(19) United States
(12) Patent Application Publication
(10) Pub. No.: US 2023/0377031 A1
(43) Pub. Date: Nov. 23, 2023

(54) Systems and Methods for Asynchronous Interaction with Time-Limited Social Image or Video Posts

(71) Applicant: Whatnot Inc., Marina Del Rey, CA (US)

(72) Inventors: Rami Khalaf, Los Angeles, CA (US); Jeff Avery, San Mateo, CA (US)

(21) Appl. No.: 18/200,534

(22) Filed: May 22, 2023

Related U.S. Application Data
(60) Provisional application No. 63/344,382, filed on May 20, 2022.

(51) Int. Cl. G06Q 30/08; G06Q 20/32; G06Q 50/00; G06F 3/04847

(52) U.S. Cl. CPC G06Q 30/08; G06Q 20/3267; G06Q 50/01; G06F 3/04847

(57) ABSTRACT

A mobile software application by which a user may publish, to a unique user profile associated with the user, time-limited image or video posts (“stories”), each story being associated with one or more items available for sale from the user (e.g., available for auction). One or more graphical user interfaces of the application enable mobile devices of further users to access the first user's story by displaying one or more images/videos in the story in conjunction with real-time information associated with the available item(s). These further users may use the GUI(s) to participate in the sale of the item(s), e.g., by placing bids, within the first user's story view. Each story published by the first user remains visible in the first user's story view for a limited duration of time, thereby making the seller's story view an accessible conduit for time-relevant information associated with the first user's items.

### CROSS-REFERENCE TO RELATED APPLICATIONS

This application claims priority to, and the benefit of the filing date of, U.S. Provisional Application No. 63/344,382, filed May 20, 2022 and titled “Systems and Methods for Asynchronous Interaction with Time-Limited Social Image or Video Posts,” the entirety of which is hereby incorporated by reference.

### TECHNICAL FIELD

The present disclosure generally relates to mobile computing device communications, and more specifically, to systems and methods for facilitating asynchronous interaction by multiple mobile computing devices with a time-limited, image or video-based social post from another mobile computing device user.

### BACKGROUND OF THE DISCLOSURE

Technological improvements to mobile computing devices, such as smartphones, smart tablets, and the like, have offered opportunities to make various interactive electronic services available via mobile computing devices, where previously such services might have only been available at most via desktop and/or laptop computers. Such electronic services have included, for example, auctions of consumer goods, including collectible items such as trading cards, toys, figurines, comic books, video games etc.

In particular, a system offered by Whatnot Inc. provides a mobile software application “Whatnot” that is available on Android and iOS devices, and which enables a seller or “host” user to offer one, two, three or more items consecutively for auction via a live auction event. IN the live auction event, the host's device records a real-time video/audio stream, which prospective bidders or “guests” can view in conjunction with a graphical user interface (GUI) that enables the guests to send and receive communications regarding the auction(s) (e.g., bids, comments, updates to items, etc.) substantially in real-time. At least these aspects of live auction events provide substantial benefits over conventional systems for online auctions, for example by enabling hosts and guests to send and receive updated information substantially in real-time without the devices having to reload or refresh the GUI by which the devices participate in the event, thus providing uninterrupted, social access to the live auction event. Further description, including system implementation details for live auction events, is provided in U.S. Pat. No. 11,196,577, filed Apr. 22, 2021, which is hereby incorporated by reference herein in its entirety.

### SUMMARY

Although the live auction events described in the foregoing provide technical and practical advantages, the present description identifies reasons that both “hosts” and “guests” in live auction events may alternatively want certain items to be made available for sale (e.g., for auction or for direct purchase) outside of the context of a live auction event. That is, it might be most optimal for a given host or guest to be able to disperse and view real-time information associated with direct purchases or auctions in an easily accessible and social manner, without needing the host or guest's device to connect to a live auction event and remain connected to the live auction event for a potentially significant duration of time (e.g., for at least a portion of a live auction event for a guest participating in an auction of an item, or an entire live auction event for a host).

In view of these needs, the present description describes systems and methods utilizing a mobile software application by which a seller may publish, to a unique user profile associated with the seller, time-limited image or video posts (referred to herein as “stories”), and associate each story with one or more items available for sale from an item inventory of the seller. Via various graphical user interfaces and other system functionalities that will be described in the present description, the published stories become visible, for a limited duration of time (e.g., 24 hours), in an easily and socially accessible “story view” associated with the seller's user profile. Other users (potential buyers or simply “buyers”) view the story view of the seller via a GUI at their respective devices, the GUI displaying a given story by displaying the image(s)/video(s) included in the story in conjunction with real-time information for the sale of one or more items associated with the story (e.g., auction information or direct purchase information). Using the GUI at their respective devices, each of the buyers can participate in the sale of the one or more items, e.g. via placing a bid or making a direct purchase, entirely within the story view of the seller. The item sale information displayed in the GUI can be automatically updated, substantially in real-time via communications with one or more servers, such that any buyer viewing the story has access to real-time item sale information, which may change over the limited duration of time (or “lifetime” of the story) based upon bids, purchases, etc. Each story posted by a seller remains publicly accessible or “active” for the limited duration of time, after which the story disappears from the seller's story view, thereby making the seller's story view an accessible conduit for time-relevant information and sales of items in the seller's item inventory.

In embodiments, one or more servers are provided. The one or more servers may include one or more processors, and one or more memories storing non-transitory computer executable instructions. The instructions, when executed via the one or more processors, may cause the one or more servers to (1) obtain, from a first client computing device operating on behalf of a first user, first information defining one or more images or videos to be included in a time-limited social post associated with a unique user profile of the first user, (2) obtain, from the first client computing device, second information defining one or more items to be made available for sale in association with the time-limited social post, the one or more items being among an item inventory associated with the unique user profile, (3) generate the time-limited social post based upon the first and second information to thereby make the post available to be viewed, via the one or more servers and for a limited duration of time, at each of a plurality of second client computing devices, and/or (4) cause an indication of availability of the time-limited social post to be displayed via a first graphical user interface (GUI) at each of the plurality of second client computing devices, wherein a user interaction with the indication via the first GUI at a particular client device from among the plurality of second client computing devices causes the particular client device to display the time-limited social post by displaying the one or more images or videos in conjunction with real-time information associated with the sale of the one or more items. The one or more servers may be configured to perform additional, fewer, and/or alternate actions, in various embodiments.

In other embodiments, a computer-implemented method is provided, the method being performed via one or more processors. The computer-implemented method may include (1) obtaining, from a first client computing device operating on behalf of a first user, first information defining one or more images or videos to be included in a time-limited social post, (2) obtaining, from the first client computing device, second information defining one or more items to be made available for sale in association with the time-limited social post, the one or more items being associated with an inventory of a unique user profile associated with the user, (3) generating the time-limited social post based upon the first and second information to thereby make the post available to be viewed, via the one or more servers and for a limited duration of time, at each of a plurality of second client computing devices, and/or (4) causing an indication of availability of the time-limited social post to be displayed via a first graphical user interface (GUI) at each of the plurality of second client computing devices, wherein a user interaction with the indication via the first GUI at a particular client device from among the plurality of second client computing devices causes the particular client device to display the time-limited social post by displaying the one or more images or videos in conjunction with real-time information associated with the sale of the one or more items. The computer-implemented method may include additional, fewer, and/or alternate actions, in various embodiments.

In yet other embodiments, one or more non-transitory computer readable media are provided. The one or more non-transitory computer readable media may store non-transitory computer executable instructions that, when executed via one or more servers, cause the one or more servers to (1) obtain, from a first client computing device operating on behalf of a first user, first information defining one or more images or videos to be included in a time-limited social post associated with a unique user profile of the first user, (2) obtain, from the first client computing device, second information defining one or more items to be made available for sale in association with the time-limited social post, the one or more items being among an item inventory associated with the unique user profile, (3) generate the time-limited social post based upon the first and second information to thereby make the post available to be viewed, via the one or more servers and for a limited duration of time, at each of a plurality of second client computing devices, and/or (4) cause an indication of availability of the time-limited social post to be displayed via a first graphical user interface (GUI) at each of the plurality of second client computing devices, wherein a user interaction with the indication via the first GUI at a particular client device from among the plurality of second client computing devices causes the particular client device to display the time-limited social post by displaying the one or more images or videos in conjunction with real-time information associated with the sale of the one or more items. The one or more non-transitory computer readable media may include additional, fewer, and/or alternate instructions, in various embodiments.

In still other embodiments, one or more non-transitory computer readable media are provided. The one or more non-transitory computer readable media may store non-transitory computer executable instructions that, when executed via one or more processors of a client computing device operating on behalf of a first user, cause the client computing device to (1) receive, via one or more graphical user interfaces (GUIs), a first one or more user interactions defining one or more images or videos to be included in a time-limited social post associated with a unique user profile of the first user, (2) receive, via the one or more GUIs, a second one or more user interactions defining one or more items to be made available for sale in association with the time-limited social post, the one or more items being among an item inventory associated with the unique user profile, and/or (3) transmit, to one or more servers, communications indicating the one or more images or videos and the one or more items to cause the time-limited social post to be generated and made available for viewing at each of a plurality of second client computing devices via the one or more servers. The one or more non-transitory computer readable media may include additional, fewer, and/or alternate instructions, in various embodiments.

In still yet other embodiments, a computer-implemented method is provided, the method being executed via one or more processors. The computer-implemented method may include (1) receiving, via one or more graphical user interfaces (GUIs) of a client computing device of a first user, a first one or more user interactions defining one or more images or videos to be included in a time-limited social post associated with a unique user profile of the first user, (2) receiving, via the one or more GUIs, a second one or more user interactions defining one or more items to be made available for sale in association with the time-limited social post, the one or more items being among an item inventory associated with the unique user profile, and/or (3) transmitting, to one or more servers, communications indicating the one or more images or videos and the one or more items to cause the time-limited social post to be generated and made available for viewing at each of a plurality of second client computing devices via the one or more servers. The computer-implemented method may include additional, fewer, and/or alternate actions, in various embodiments.

In still other embodiments, a client computing device is provided. The computing device may include one or more processors, and one or more memories storing non-transitory computer executable instructions. The instructions when executed via the one or more processors, cause the client computing device, operating on behalf of a first user, to (1) receive, via one or more graphical user interfaces (GUIs), a first one or more user interactions defining one or more images or videos to be included in a time-limited social post associated with a unique user profile of the first user, (2) receive, via the one or more GUIs, a second one or more user interactions defining one or more items to be made available for sale in association with the time-limited social post, the one or more items being among an item inventory associated with the unique user profile, and/or (3) transmit, to one or more servers, communications indicating the one or more images or videos and the one or more items to cause the time-limited social post to be generated and made available for viewing at each of a plurality of second client computing devices via the one or more servers. The client computing device may be configured to perform additional, fewer, and/or alternate actions, in various embodiments.

In other embodiments, one or more non-transitory computer readable media are provided. The one or more non-transitory computer readable media may store non-transitory computer executable instructions that, when executed via one or more processors of a client computing device operating on behalf of a first user, cause the client computing device to (1) display, via a first graphical user interface (GUI) an indication of availability of time-limited social post associated with a unique user profile of a second user, the time-limited social post being associated with (i) one or more images or videos, and (ii) a sale of one or more items, (2) receive a first one or more user interactions with the indication, (3) in response to the first one or more user interactions with the indication, and via communications with one or more servers, obtain (i) the one or more images or videos, and (ii) real-time information defining one or more parameters associated with the sale of the one or more items, and/or (4) display the time-limited social post via a second GUI, the displaying of the time-limited social post (i) comprising displaying the one or more images or videos in conjunction with real-time information associated with the sale of the one or more items, and (ii) enabling the client computing device to participate in the sale of the one or more items via the post. The one or more non-transitory computer readable media may include additional, fewer, and/or alternate instructions, in various embodiments.

In still other embodiments, a computer-implemented method is provided, the method being executed via one or more processors. The computer-implemented method may include (1) displaying, via a first graphical user interface (GUI) of a client computing device of a first user, an indication of availability of time-limited social post associated with a unique user profile of a second user, the time-limited social post being associated with (i) one or more images or videos, and (ii) a sale of one or more items, (2) receiving a first one or more user interactions with the indication, (3) in response to the first one or more user interactions with the indication, and via communications with one or more servers, obtaining (i) the one or more images or videos, and (ii) real-time information defining one or more parameters associated with the sale of the one or more items, and/or (4) displaying the time-limited social post via a second GUI, the displaying of the time-limited social post (i) comprising displaying the one or more images or videos in conjunction with real-time information associated with the sale of the one or more items, and (ii) enabling the client computing device to participate in the sale of the one or more items via the post. The computer-implemented method may include additional, fewer, and/or alternate actions, in various embodiments.

In still other embodiments, a client computing device is provided. The computing device may include one or more processors, and one or more memories storing non-transitory computer executable instructions. The instructions when executed via the one or more processors, cause the client computing device, operating on behalf of a first user, to (1) display, via a first graphical user interface (GUI) an indication of availability of time-limited social post associated with a unique user profile of a second user, the time-limited social post being associated with (i) one or more images or videos, and (ii) a sale of one or more items, (2) receive a first one or more user interactions with the indication, (3) in response to the first one or more user interactions with the indication, and via communications with one or more servers, obtain (i) the one or more images or videos, and (ii) real-time information defining one or more parameters associated with the sale of the one or more items, and/or (4) display the time-limited social post via a second GUI, the displaying of the time-limited social post (i) comprising displaying the one or more images or videos in conjunction with real-time information associated with the sale of the one or more items, and (ii) enabling the client computing device to participate in the sale of the one or more items via the post. The client computing device may be configured to perform additional, fewer, and/or alternate actions, in various embodiments.

### BRIEF DESCRIPTION OF THE FIGURES

FIG. 1 is a block diagram of an example computing environment, in accordance with some embodiments of the present description;

FIG. 2 is a signal diagram detailing example actions associated with posting and viewing a time-limited story including one or more images/videos associated with one or more items, in accordance with some embodiments;

FIG. 3A is an example representation of a story creation graphical user interface (GUI) executing on a mobile computing device, in accordance with some embodiments;

FIG. 3B is an example representation of another story creation GUI executing on a mobile computing device, in accordance with some embodiments;

FIG. 3C is an example representation of an image-based story creation GUI executing on a mobile computing device, in accordance with some embodiments;

FIG. 3D is an example representation of a video-based story creation GUI executing on a mobile computing device, in accordance with some embodiments;

FIG. 3E is an example representation of still another story creation GUI executing on a mobile computing device, in accordance with some embodiments;

FIG. 4A is an example representation of an item identification GUI executing on a mobile computing device, in accordance with some embodiments;

FIG. 4B is an example representation of another item identification GUI executing on a mobile computing device, in accordance with some embodiments;

FIG. 4C is an example representation of still another item identification GUI executing on a mobile computing device, in accordance with some embodiments;

FIG. 4D is an example representation of an item creation GUI executing on a mobile computing device, in accordance with some embodiments;

FIG. 4E is an example representation of a continuation of the item creation GUI of FIG. 4D, executing on a mobile computing device, in accordance with some embodiments;

FIG. 4F is an example representation of another item identification GUI executing on a mobile computing device, in accordance with some embodiments;

FIG. 4G is an example representation of a continuation of the item creation GUI of FIG. 4F, executing on a mobile computing device, in accordance with some embodiments;

FIG. 4H is an example representation of still another story creation GUI executing on a mobile computing device, in accordance with some embodiments;

FIG. 4I is an example representation of a story preview GUI executing on a mobile computing device, in accordance with some embodiments;

FIG. 5A is an example representation of a home screen GUI executing on a mobile computing device, in accordance with some embodiments;

FIG. 5B is an example representation of another home GUI executing on a mobile computing device, in accordance with some embodiments;

FIG. 5C is an example representation of a user profile GUI executing on a mobile computing device, in accordance with some embodiments;

FIG. 5D is an example representation of a continuation of the user profile GUI of FIG. 5C, executing on a mobile computing device, in accordance with some embodiments;

FIG. 5E is an example representation of a story-based auction GUI executing on a mobile computing device, in accordance with some embodiments;

FIG. 5F is an example representation of another story-based auction GUI executing on a mobile computing device, in accordance with some embodiments;

FIG. 5G is an example representation of still another story-based auction GUI executing on a mobile computing device, in accordance with some embodiments;

FIG. 5H is an example representation of a profile overlay GUI executing on a mobile computing device, in accordance with some embodiments;

FIG. 6A is an example representation of a story-based direct purchase GUI executing on a mobile computing device, in accordance with some embodiments;

FIG. 6B is an example representation of another story-based direct purchase GUI executing on a mobile computing device, in accordance with some embodiments;

FIG. 6C is an example representation of still another story-based direct purchase GUI executing on a mobile computing device, in accordance with some embodiments;

FIG. 6D is an example representation of still yet another story-based direct purchase GUI executing on a mobile computing device, in accordance with some embodiments;

FIG. 7A is an example representation of a story editing GUI executing on a mobile computing device, in accordance with some embodiments;

FIG. 7B is an example representation of a story deletion GUI executing on a mobile computing device, in accordance with some embodiments;

FIG. 8 is a block diagram of an example mobile computing device and server, in accordance with some embodiments;

FIG. 9A is a flow diagram of an example story posting/access method implemented via one or more servers, in accordance with some embodiments;

FIG. 9B is a flow diagram of an example story posting method implemented via a mobile computing device, in accordance with some embodiments; and

FIG. 9C is a flow diagram of an example story access method implemented via a mobile computing device, in accordance with some embodiments.

### DETAILED DESCRIPTION

Embodiments of the present description relate to computing systems and methods that, broadly speaking, utilize a software application implemented at mobile electronic computing devices and/or other electronic computing devices, the application facilitating auctions and/or direct purchases of collectible items such as trading cards, card packs, toys, figurines, comic books, manga, vintage video games, clothing, etc.

A first user of the application, referred to herein as a “seller,” may create and publish (or “post”) to their unique user profile a time-limited, image and/or video-based social post (“story”) associated with one or more items available for auction or direct purchase from an item inventory of the seller's profile. Via various graphical user interfaces and other system functionalities that will be described in the present description, the published stories become visible, for a limited duration of time (e.g., 24 hours), in an easily and socially accessible “story view” associated with the seller's user profile. Other users (potential buyers or simply “buyers”) view the story view of the seller via a GUI at their respective devices, the GUI displaying a given story by displaying the image(s)/video(s) included in the story in conjunction with real-time information for the sale of one or more items associated with the story (e.g., auction information or direct purchase information). Using the GUI at their respective devices, each of the buyers can participate in the sale of the one or more items, e.g. via placing a bid or making a direct purchase, entirely within the story view of the seller. The item sale information displayed in the GUI can be automatically updated, substantially in real-time via communications with one or more servers, such that any buyer viewing the story has access to real-time item sale information, which may change over the limited duration of time (or “lifetime” of the story) based upon bids, purchases, etc. Each story posted by a seller remains publicly accessible or “active” for the limited duration of time, after which the story disappears from the seller's story view, thereby making the seller's story view an accessible conduit for time-relevant information and sales of items in the seller's item inventory. Moreover, as will be described in the present description, various functionalities of the mobile software application described herein may make the seller's user profile and story view easily and intuitively accessible to other users of the application.

These story-based features of the mobile software application may be integrated with various other features, which can include for example the “live auction events” described in the foregoing background section of the present description. Through a live auction event, the seller (or “host” of the event) may auction (and/or offer for direct purchase) one or more items from the seller's inventory by transmitting a real-time video stream for display at devices of buyers (or “guests” of the event) in conjunction, the real-time video being displayed at buyers' devices in conjunction with real-time information associated with the one or more items. Further description regarding these live auction events is provided in U.S. Pat. No. 11,196,577, filed Apr. 22, 2021. Generally speaking, though, live auction events may make various interactive graphical user interfaces (GUIs) available to guest devices, via which guests may competitively bid on or directly purchase items, post comments for viewing by other guests and/or the host, explore other items available from the host, and/or access various other social features in conjunction while viewing the real-time video stream at a guest device. The implementation of live auction events may involve a “publish/subscribe” messaging architecture, via which one or more servers act as a message broker to distribute messages to hosts and guests, based upon stored registry information and publish/subscribe logic that defines which devices (i.e., which hosts and/or guests) are to receive particular classes of messages published or generated at the server(s) during progression of the live auction event. Each host and guest forms a persistent connection to the server(s) while participating in the live auction event, and connected hosts and guests are able to exchange substantially real-time information in the event without interrupting the transmitting or displaying of the real-time video stream (e.g., without needing to refresh or reload pages), thus providing a robust and stable social environment via which users may participate in auction/purchase of items.

While the live auction events described in the foregoing provide technical and practical advantages over conventional online auction systems, the present description identifies reasons that both hosts and guests might additionally or alternatively want certain items to be made available for sale (e.g., for auction or for direct purchase) outside of the context of a live auction event. A guest, for example, may find that participating in the live auction event requires their personal attention (and their device's attention) for a significant duration of time (e.g., for at least the length of an auction of a given item). Additionally or alternatively, limitations of the guest's device itself may prevent the device from participating in the live auction event for as long as the guest would like (e.g., due to limited processing power, data rate availability or stability to persistently connect to the server(s), and/or remaining battery capacity available to the device). Hosts may encounter at least the same considerations, exacerbated by the fact that the host may need to be persistently connected to the live auction event for the entirety of the event.

Still, hosts and guests would optimally wish to be able to disperse and view real-time information associated with direct purchases or auctions in an easily accessible and social manner (as would be achieved in a live auction event), without requiring the persistent attention and device resources associated with participating in a live auction event. Hosts (or “sellers”) may wish to spotlight their items in an accessible and social manner, even if they are unable or unavailable to host a live auction event. Similarly, guests (or “buyers”) may wish to explore, bid on, and/or purchase spotlighted items from various sellers, without needing to connect to a live auction event for any duration of time (e.g., the buyer may instead only want to use the mobile software application for short intervals of time to “check on” items, for example ten seconds, thirty seconds, one to two minutes, etc.).

In view of these observed needs, the story-based features of the present description enable implementation of auctions and/or direct purchases through a seller's “story view” that is easily and intuitively accessible via various graphical user interfaces, but which does not require connection to a live auction event. These story-based features will be understood from the present description in reference to example systems diagrams, signal diagrams, GUIs, and block diagrams. Each time-limited story posted by a seller to their respective profile may remain viewable in their story view for a limited duration of time, during which buyers may view item information, place bids, and/or perform purchases within the seller's story view. Moreover, various GUIs made available to prospective buyers enable buyers to navigate among two, three or more stories in a story view of a same seller, and/or navigate among story views two, three, or more sellers in which the buyers are interested.

### Example Computing Environment

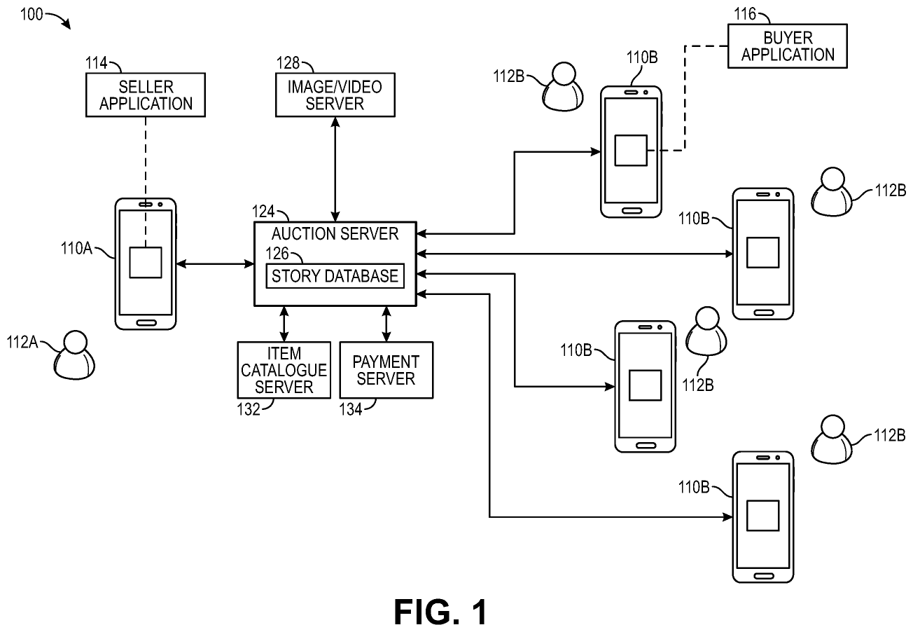

FIG. 1 illustrates a block diagram of an example computing environment 100 via which techniques of the present description may be implemented. In particular, elements of the computing environment 100 may facilitate posting and accessing of stories posted by sellers, and the interactions with stories described herein (e.g., with respect to auctions and/or direct purchases of items via stories). Although various components of the example computing environment 100 will be described below, it should be understood that additional, fewer, and/or alternate components may be envisioned in various embodiments, without necessarily deviating from the techniques described herein.

The computing environment includes a first mobile computing device 110a associated with a first user 112a, and a plurality of second mobile computing devices 110b associated with respective ones of a plurality of second users 112b. Mobile computing devices 110a and 110b may include, for example, smartphones, smart tablets, smart wearable devices, other suitable mobile devices, or some combination thereof. Although mobile computing devices 110a and 110b are discussed herein, it should be understood that the mobile computing devices 110a and 110b may, in some embodiments, be substituted for desktop computers and/or other non-mobile devices.

In the example environment 100, the first user 112a represents a seller, e.g., a person or entity making one or more items for auction or direct purchase via the story features of the present description. Accordingly, the first mobile computing device 110a is generally referred to herein as a seller device 110a. The second users 112b in this example represent prospective buyers (or simply “buyers”) who may access the seller's story view to view one or more stories posted by the seller, to bid on and/or purchase items via the one or more stories, etc. Accordingly, the mobile computing devices 110b are referred to herein buyer devices 110b.

Each of the mobile computing devices 110a and 110b may respectively comprise one or more computer processors and one or more non-transitory computer memories storing instructions that, when executed via the one or more processors, cause the device 110a or 110b to perform the actions attributed to the device 110a or 110b in the present description. In the case of the host device 110a, the one or more non-transitory memories may store one or more software applications 114 (“seller application”) including one or more sets of non-transitory computer executable instructions that, when executed via the one or more processors, cause the seller device 110a to perform actions described herein. Similarly, the one or more memories of each buyer device 110b may store one or more software applications 116 (“buyer application”) including one or more sets of non-transitory computer executable instructions that, when executed via the one or more processors of the buyer device 110b, cause the buyer device 110b to perform actions described herein. Although seller application 114 and buyer application 116 are illustrated as separate blocks in FIG. 1, it should be understood that applications 114 and 116 may represent separate aspects of the same one or more applications (e.g., a single application stored and executed both at devices 110a and 110b, and each user 112a or 112b may alternatively operate as a seller or buyer using the single application). Each of the seller device 110a and buyer devices 110b may comprise one or more application programming interfaces (APIs) operable for example to (1) generate and display GUIs, (2) capture or otherwise obtain still images and/or videos, (3) display images, videos, item information, and/or other information described herein, (4) communicate with one or more servers (e.g., to receive real-time item information and/or communicate bids or purchases placed via the each device), and/or perform other actions described herein.

The seller device 110a (and, in some instances, the buyer devices 110b) may comprise one or more camera devices, which may for example capture still images and/or video content to be included in a story of a seller 112a, or capture a real-time video stream for a live auction event. Additionally, in some embodiments, the seller device 110a (and in some instances, the buyer devices 110b) includes one or more microphones and/or speaker, which may capture, transmit, and/or play audio (e.g., accompanying audio in a video, or audio to be played in conjunction with display of one or more still images in a story). The one or more camera devices, microphones, and/or speakers may include integrated devices (e.g., a camera, microphone, or speaker natively included in a mobile computing device) and/or devices otherwise communicatively tethered to the seller device 110a or buyer device 110b (e.g., a peripheral webcam, speaker, or microphone connected wiredly or wirelessly to the mobile computing device). Additionally, each of the seller device 110a and buyer devices 110b may include one or more interactive I/O units (e.g., touchscreens, touchpads, keyboard, etc.) enabling navigation of graphical user interfaces, viewing of images and/or videos in the context of a story or a real-time video stream, and/or interactive functionalities described herein.

An auction server 124 (i.e., one or more servers) may facilitate communications among devices 110a and 110b, and may store various information associated with implementation of the story features described herein. For example, the auction server 124 may store and distribute information relating to items, implement logic relating to auctions and/or direct purchases of items via stories, receive and host stories posted by seller devices 110a, and/or provide access to stories at respective buyer devices 110b=. The auction server 124 may include one or more processors and one or more non-transitory computer readable memories storing instructions that, when executed via the one or more processors, cause the auction server 124 to perform the actions described herein. The one or more non-transitory memories of the auction server 124 may include a story database 126 storing information including, for example, images, videos, and/or item information for stories posted to seller's story views, status information regarding ongoing auctions and/or direct purchases of items via stories (e.g., current bid prices, bid histories, remaining quantities of items for sale, buyer offers for direct purchase, view metrics, etc.), device configuration information associated with devices 110a and/or 110b, and/or user profile information regarding users 112a and/or 112b.

The auction server 124 may communicate with still additional servers to facilitate other functions described herein. For example, an image/video server 128 may facilitate operations of the auction server 124 by storing images/videos posted by a seller 112a as a story, and/or additional images/videos associated with items (e.g., stored images/videos that the seller 112a may elect to use in a story, rather than taking their own images/videos at device 110a). Additionally or alternatively, an item catalogue server 132 may store a listing of known items, from among which sellers 112a may designate items to be listed in their respective item inventors and to be included for auction or purchase via posted stories. Still additionally or alternatively, a payment server 134 may store and process payment information relating to sellers 112a and/or buyers 112b. Although each of the auction server 124, image/video server 128, item catalogue server 132, and payment server 134 are described in singular herein, it should be understood that each of the servers 124, 128, 132, and 134 may respectively comprise one or more server devices, with functions thereof being distributed among the one or more servers.

Arrows in FIG. 1 represent signal communications exchanged among the elements of the computing environment 100. Elements of the computing environment 100 may communicate via any suitable one or more communications networks (e.g., the Internet, a wired or wireless local area network (LAN), etc.). Elements of the computing environment 100 may communicate of via any suitable one or more communication protocols, including for example a mobile cellular communications protocol (e.g., CDMA, GSM, EV-DO, LTE, IP, etc.), one or more IEEE 802.11 protocols (e.g., Wi-Fi), Bluetooth, and/or other suitable protocols in accordance with the computing capabilities of respective elements of the computing environment 100.

Generally, each of the image/video server 128, the item catalogue server 132, and the payment servers 134 may respectively comprise one or more processors and one or more non-transitory memories storing computer executable instructions that, when executed by the one or more processors, cause the server(s) to perform actions described herein. Although arrows in FIG. 1 connect the mobile computing devices 110a and 110b to the servers 128, 132, and 134 by way of the one or more auction servers 124, it should be noted that in some embodiments, the server(s) 128, 132, and/or 134 may exchange communications directly with the mobile computing devices 110a and 110b. Furthermore, although the servers 124, 128, 132, and 134 are illustrated in FIG. 1 as separate elements, it should be understood that functions of the servers 124, 128, 132 and 134 may be combined in various manners, in some embodiments. For example, in some embodiments, the auction server 124 is configured to also perform at least some of the functions of the image/video server 128, the item catalogue server 132, and/or the payment server 134.

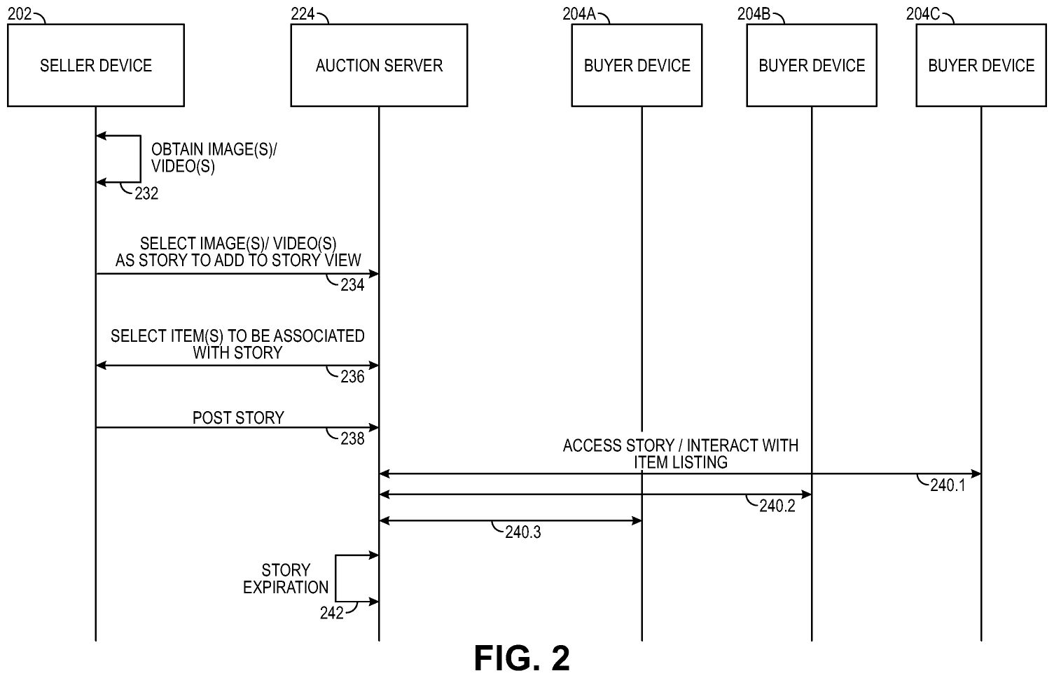

Subsequent portions of the present description, with reference to FIGS. 2, 3A-3E, 4A-4I, 5A-5H, 6A-6D, 7A, 7B, and 8A-8C, provide examples of signal communications, GUIs, and computer-implemented methods associated with implementation of the story-based features described herein. In various embodiments, described communications, GUIs, actions, etc. may be implemented by suitable components of the computing environment 100 described above. In instances where example processes are described with reference to signal diagrams, it should be understood that the example processes may include additional, fewer, and/or alternate actions, in various embodiments. Furthermore, order actions of the described processes may vary from the order illustrated in the signal diagrams. Where interactive GUIs at a mobile computing device are described, interactions with the interactive GUIs may occur, for example, via touchscreen interactions, voice commands, and/or other suitable forms of user input.

### Example Process of Posting and Accessing a Story

FIG. 2 illustrates a signal diagram of an example process of posting and accessing a time-limited story including one or more still images and/or videos associated with a sale (e.g., auction) of one or more items. The process as depicted in FIG. 2 may include communications among an auction server 224 (e.g., the auction server 124 of FIG. 1), a seller device 202 (e.g., seller device 110a of seller user 112a executing the seller application 114), and buyer devices 204a, 204b, and 204c (e.g., respective buyer devices 110b of respective buyers 112b executing the buyer application 116). Although the server 224 is referred to herein as the “auction server,” it should be understood that the auction server 224 as described herein may additionally/alternatively implement functionalities of other servers of the present description, where appropriate. For example, in some embodiments, the auction server 224 may implement functionalities of the image/video server 128, the item catalogue server 132, and/or the payment server 134 of FIG. 1.

It should be noted that the description of the process of FIG. 2 will be described at a very high level, to provide a general overview of concepts to be described in still further detail in the present description. Description of FIG. 2 will offer examples of some embodiments, and these and other embodiments will be described in still further detail with respect to subsequent figures, which include representations of example graphical user interfaces (GUIs) via which actions of the example process of FIG. 2 may be implemented. Moreover, additional actions may be added to the process of FIG. 2, including any suitable actions described in the present description, in various embodiments.

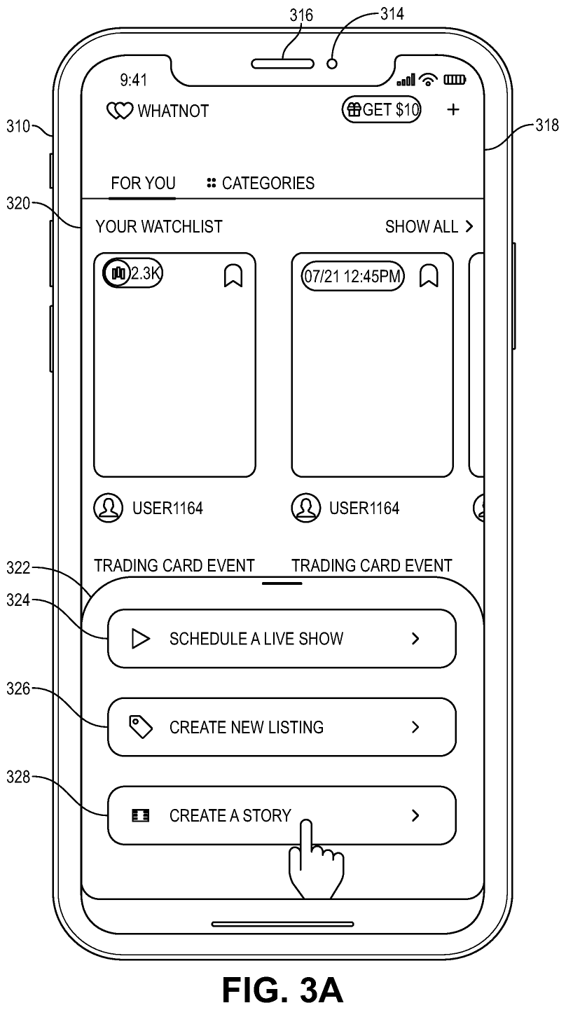

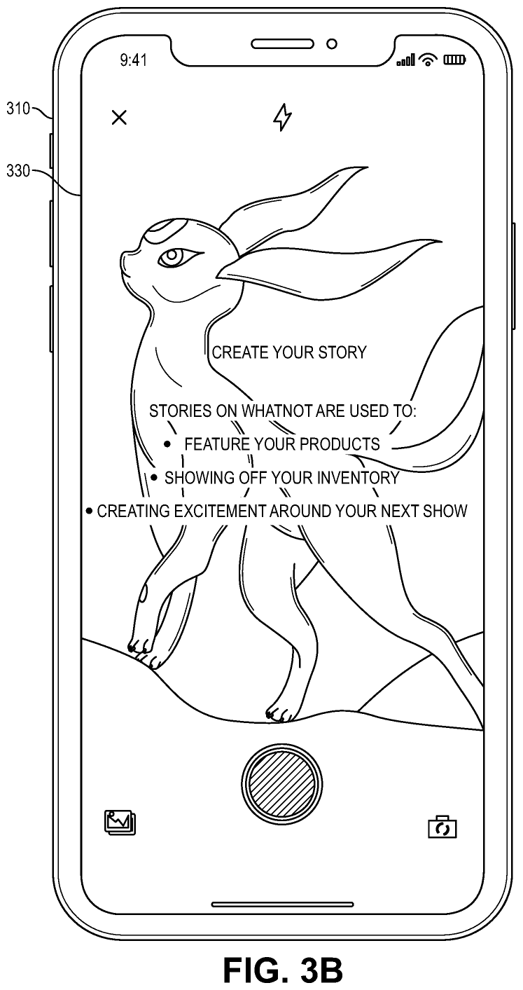

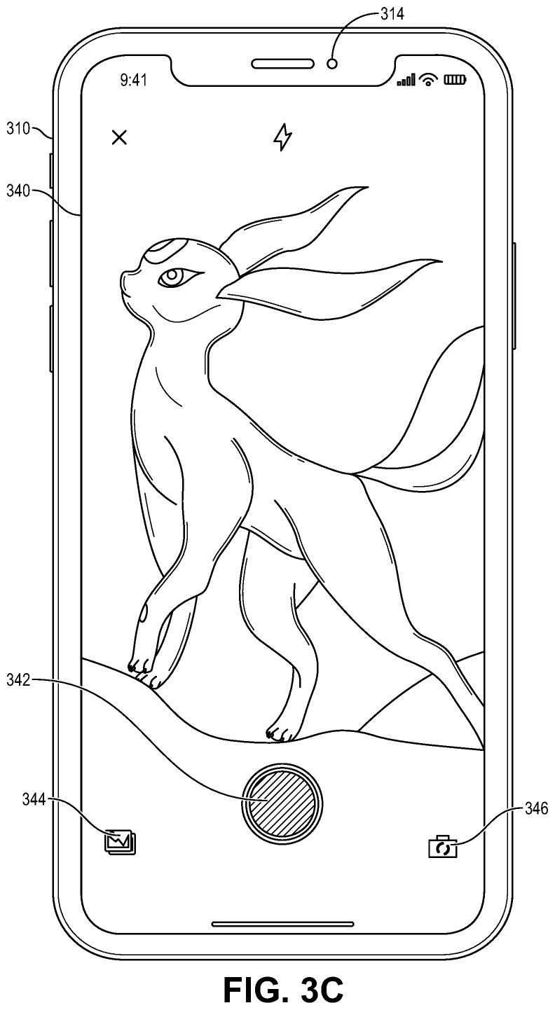

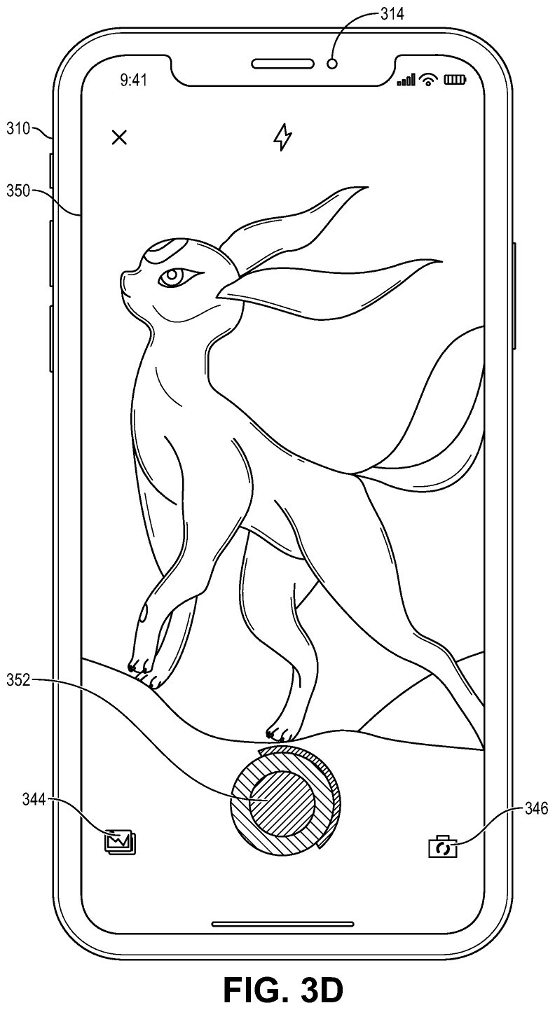

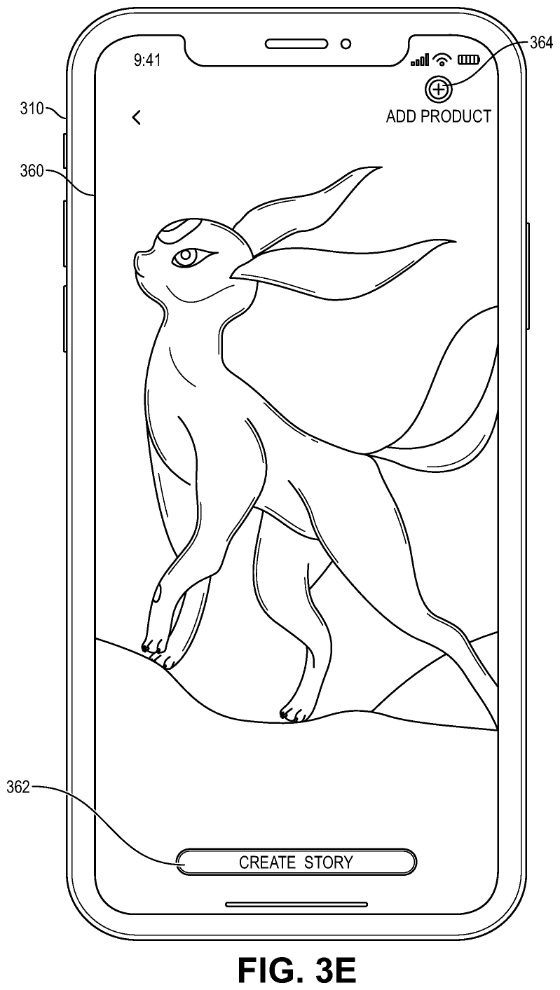

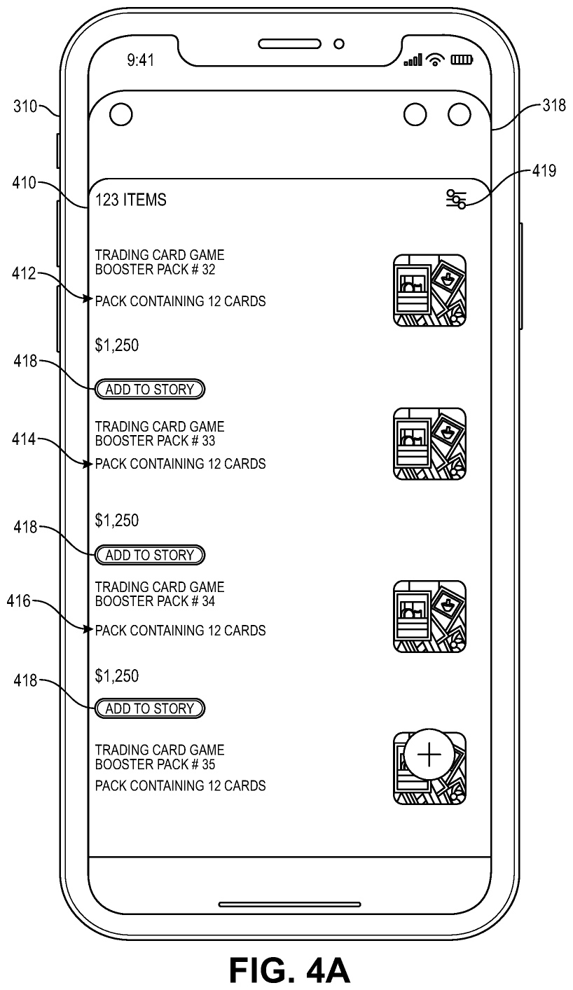

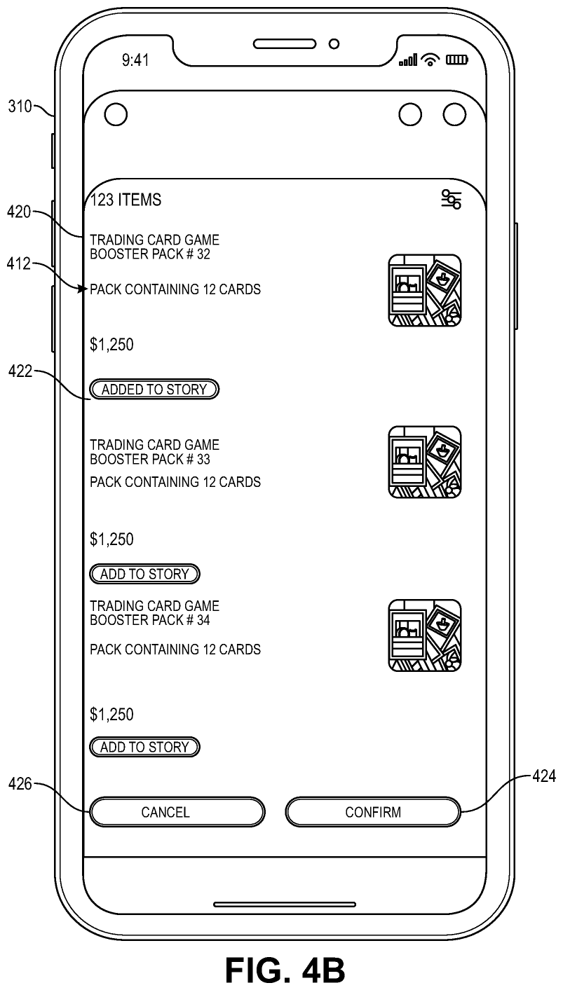

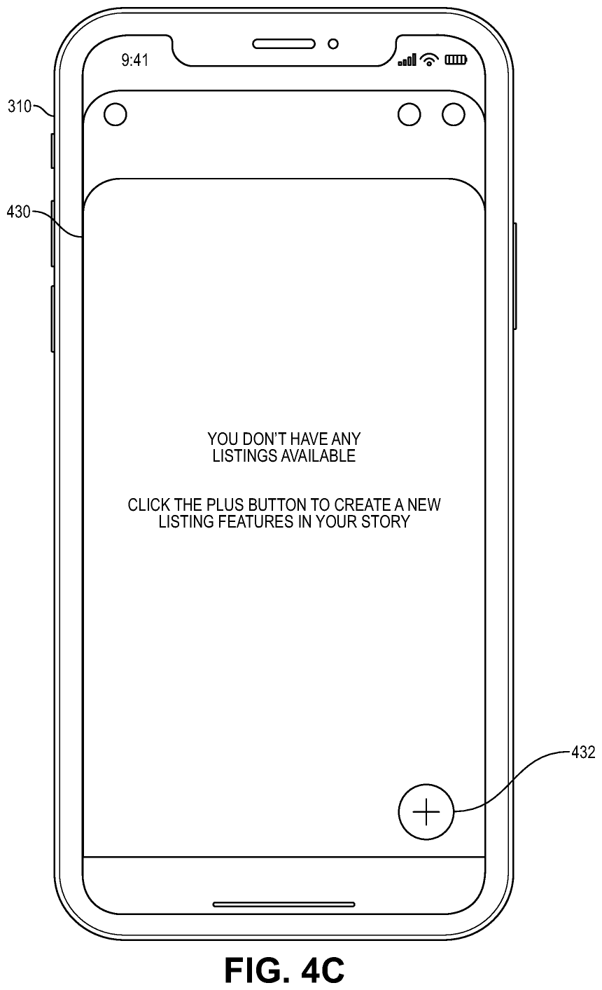

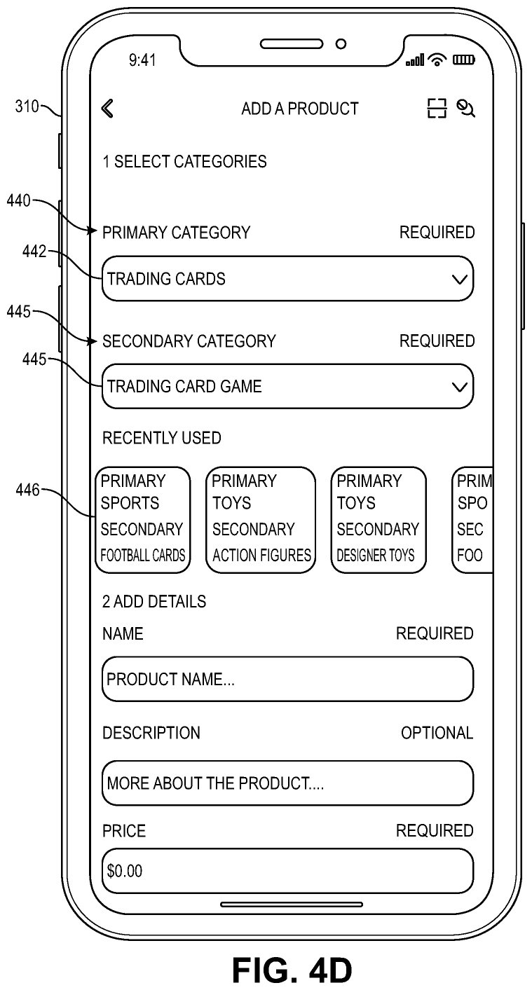

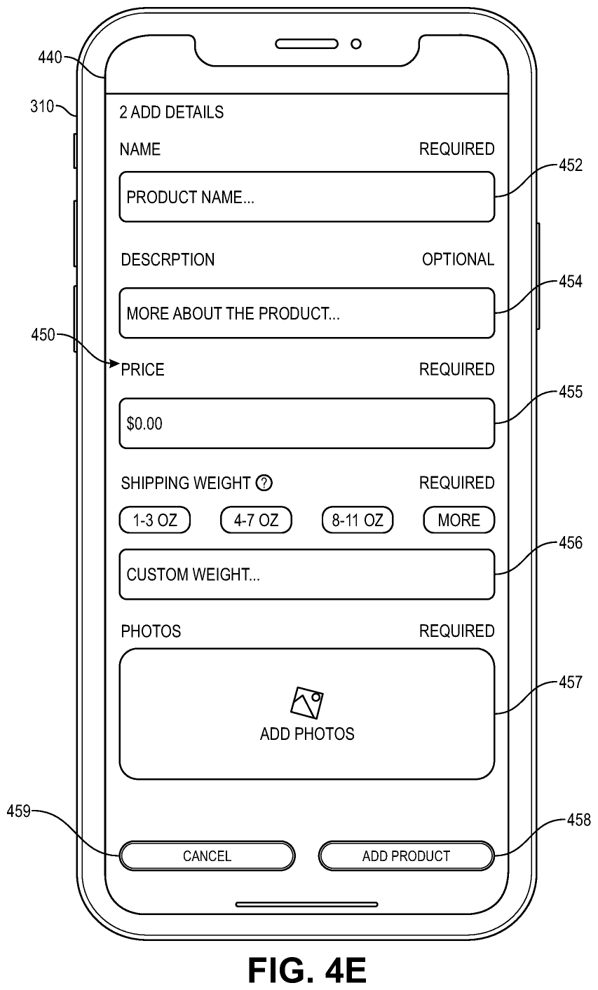

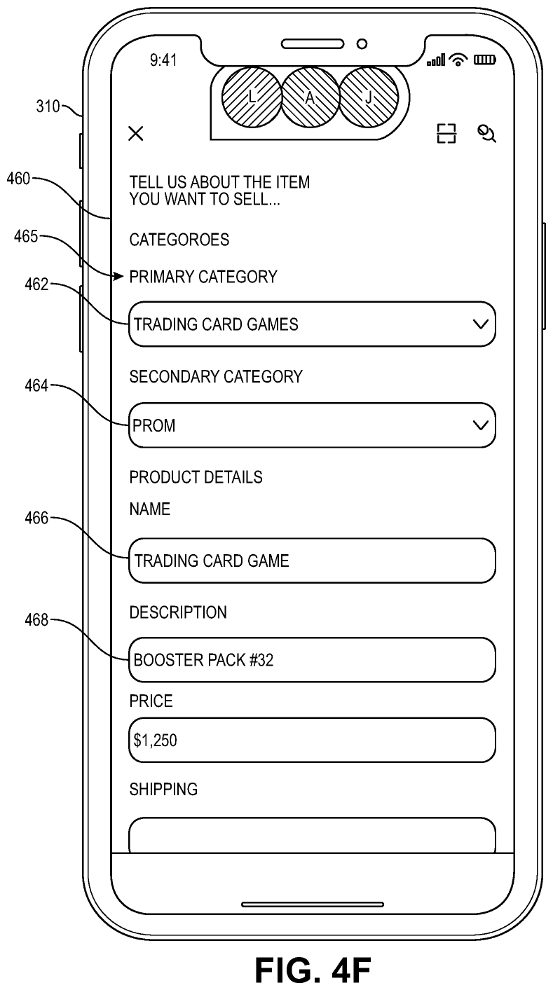

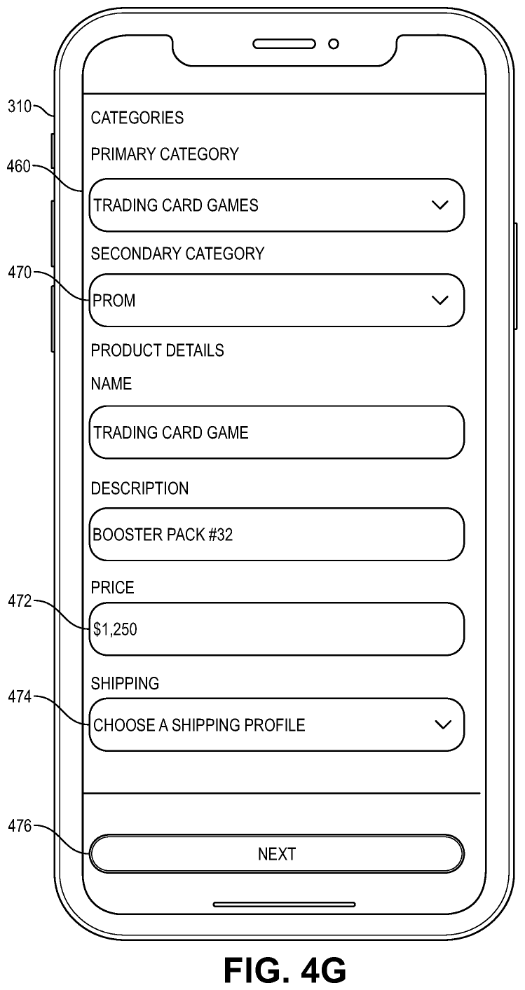

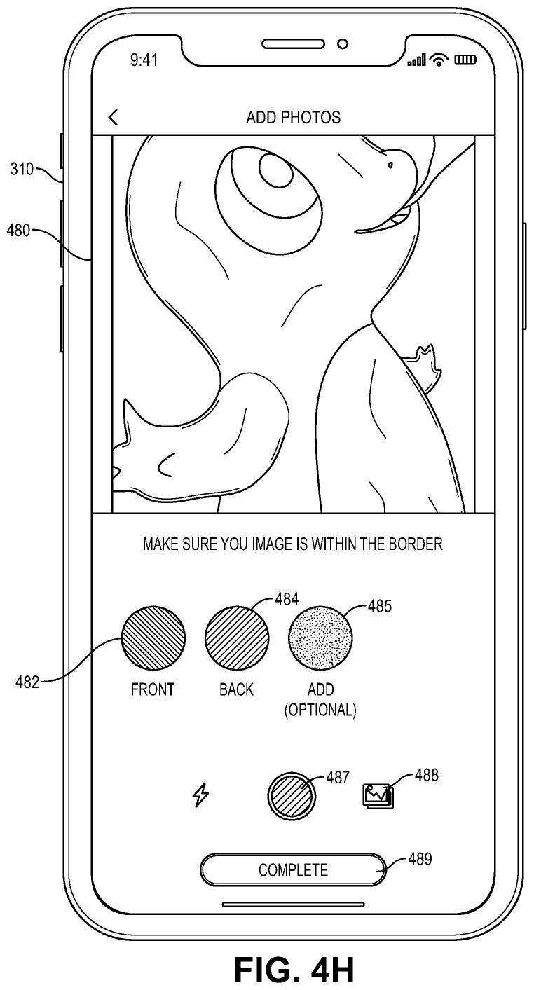

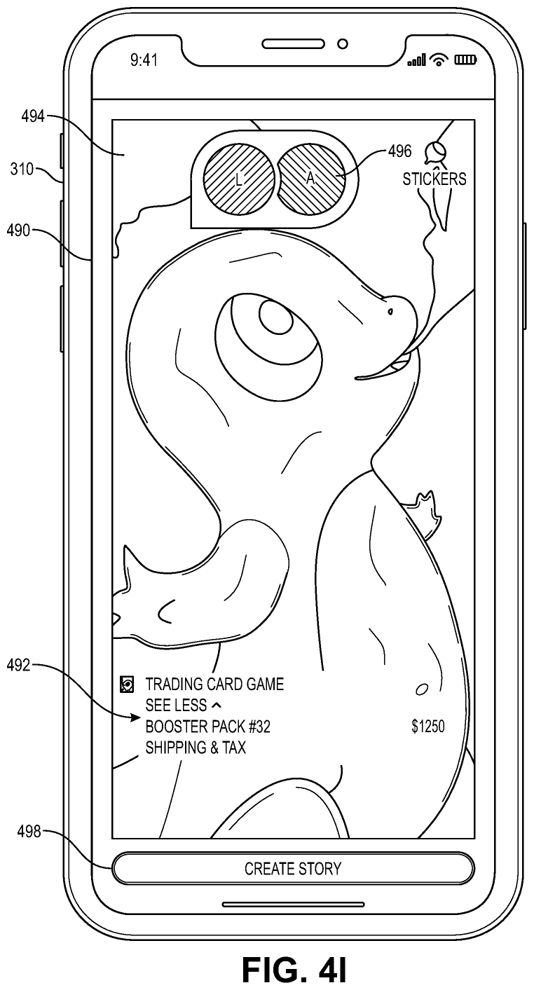

The process as illustrated in FIG. 2 begins with the seller device 202 obtaining one or more still images and/or videos (232) that are to be included in a story by a seller (i.e., the person or entity using the seller device 202). In embodiments, the one or more images and/or videos may include at least one image or videos captured via a camera unit of the seller device 202 (e.g., via a camera functionality in the seller application, or via another camera application of the seller device 202). Additionally or alternatively, though, the one or more images and/or videos can include locally-stored images/videos obtained by the seller device 202 via other means (e.g. an image or video previously downloaded to the seller device 202 from the Internet, or received via USB data transfer, AirDrop®, etc.). Still additionally or alternatively, the one or more images and/or videos may include one or more images or videos from the auction server 224 (that is, the seller device 202 may “look up” and select images/videos stored by the server 224, e.g., images/videos associated with an item that is to be auctioned or offered for purchase via the story). In any case, the process as illustrated in FIG. 2 may continue with the seller device 202 (e.g., the seller) selecting the one or more images and/or videos to be included as a story to be added seller's story view (234). In embodiments in which the one or more images/videos are obtained at action 232 using the seller application, selecting the one or more images and/or videos at action 234 may coincide at least in part with action 232. The present description with respect to FIGS. 3A-3E and 4A-4I will describe example GUIs via which the seller device 202 may obtain and select one or more images and/or videos to be included in a story.

The process of FIG. 2 further includes selecting one or more items to be associated with the story (236). In embodiments, the one or more items are selected from the seller's unique inventory, which may include a list of one, two, three or more items previously added by the seller to the seller's profile (e.g., items selected and added by the seller from among an existing item catalogue defined by the item catalogue server 132 of FIG. 1). If the one or more items to be featured in the story are not already in the seller's inventory, associating the story with a selected one or more items at action 236 may include defining a new item to be included in the seller's item inventory of the seller. Selecting the one or more items may further include setting information for auctioning the one or more items or for direct purchase of the one or more items. This information can include, for example, the name of an item, a description of an item, a category, subcategory or tag associated with an item, an initial auction price of the item, a duration of an auction for an item, a direct purchase price for an item, a shipping profile for the item, a quantity of the item that is available, and/or other suitable information described herein. Example processes and GUIs associated with the action 236 be described with respect to FIGS. 4A-4I.

Once the one or more images/videos are selected for the story and the one or more items are associated therewith, the seller device 202 may publish (or “post”) the story to the auction server 224 (238). Posting the story to the auction server 224 makes the story able to be discovered and viewed at each of the buyer devices 204a, 204b, and 204c (e.g., via the buyer application 116 executing at devices 204a, 204b, and 204c) via communication with the auction server 224. Specifically, the story is accessible via the auction server 224 for a limited duration of time, referred to herein as a “lifetime” of the story (e.g., 24 hours, or alternatively one hour, two hours, four hours, eight hours, twelve hours, 48 hours, etc.). In embodiments, while the auction server 224 sets and enforces an upper limit on the lifetime of the story, the seller device 202 may cause the story to be deleted at any time within the story's lifetime. In some embodiments, the auction server 224 automatically notifies one or more of the buyer devices 204a-204c of the new story being posted by the seller, e.g., when a user of one of the buyer devices 204a-204c has “followed” the seller or followed a category relevant to the seller.

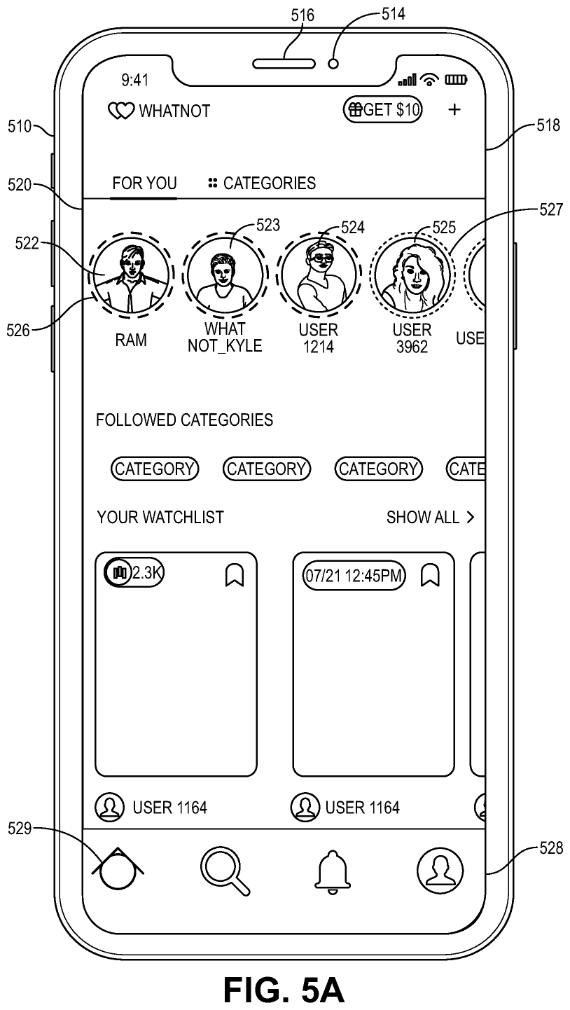

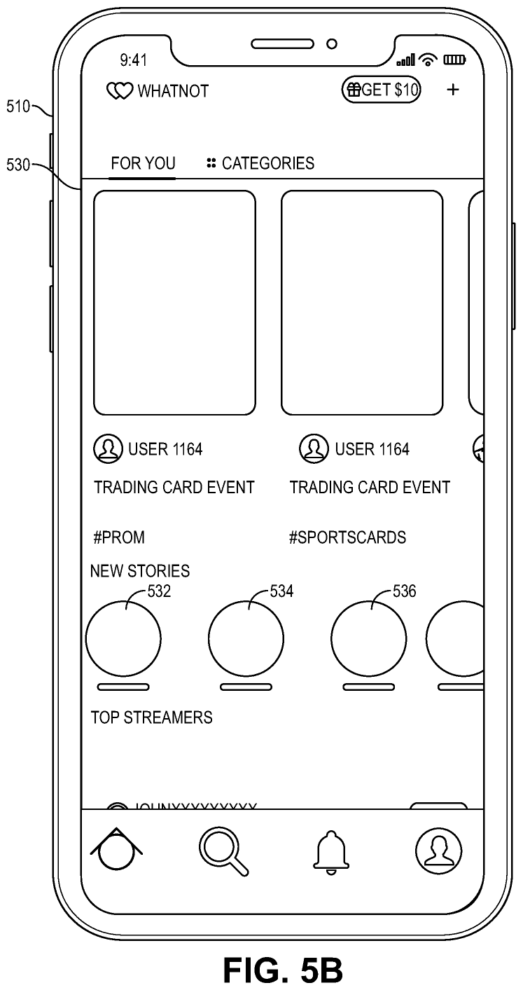

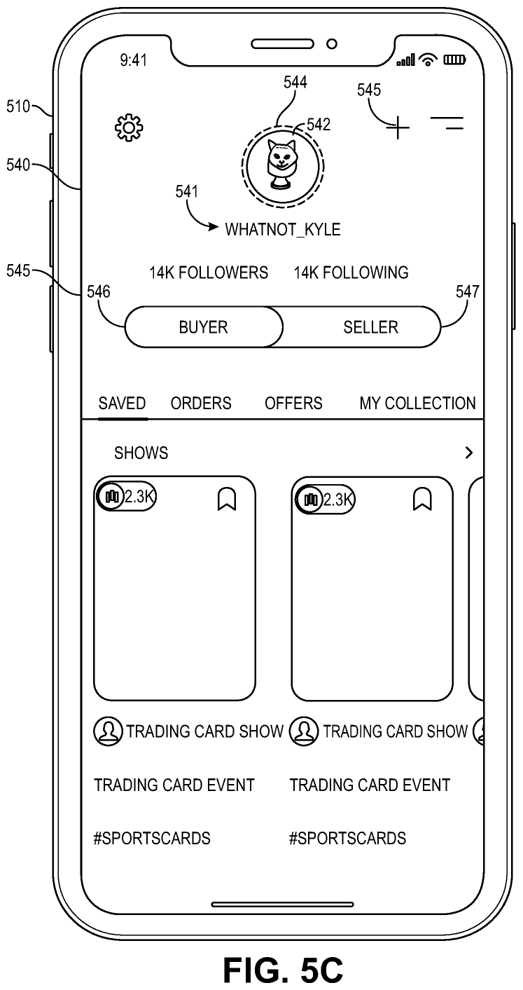

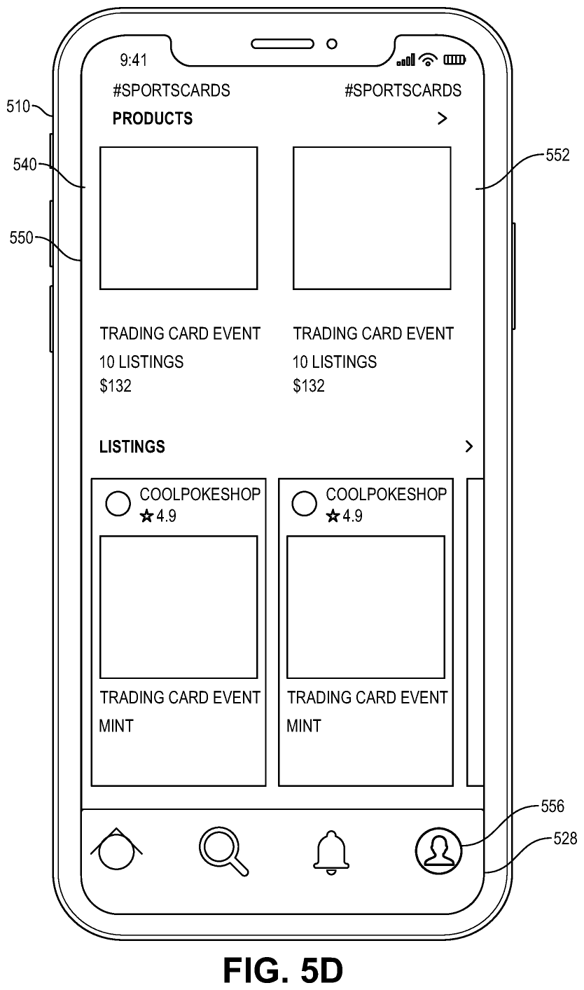

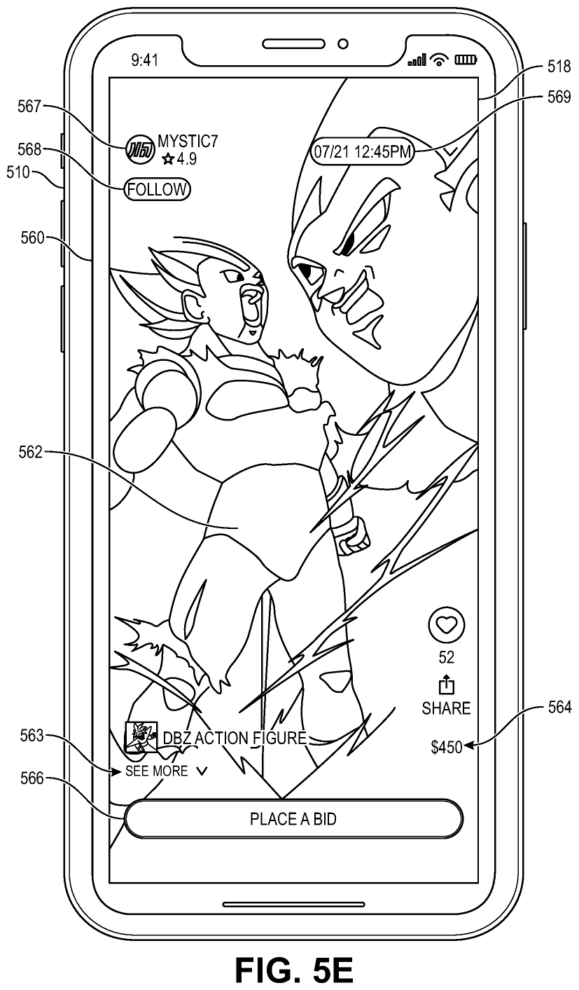

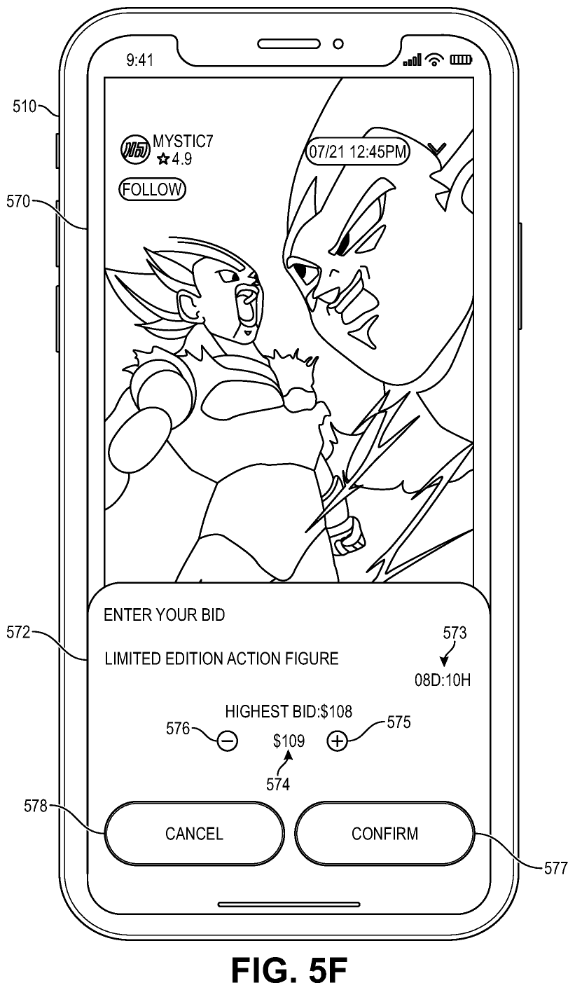

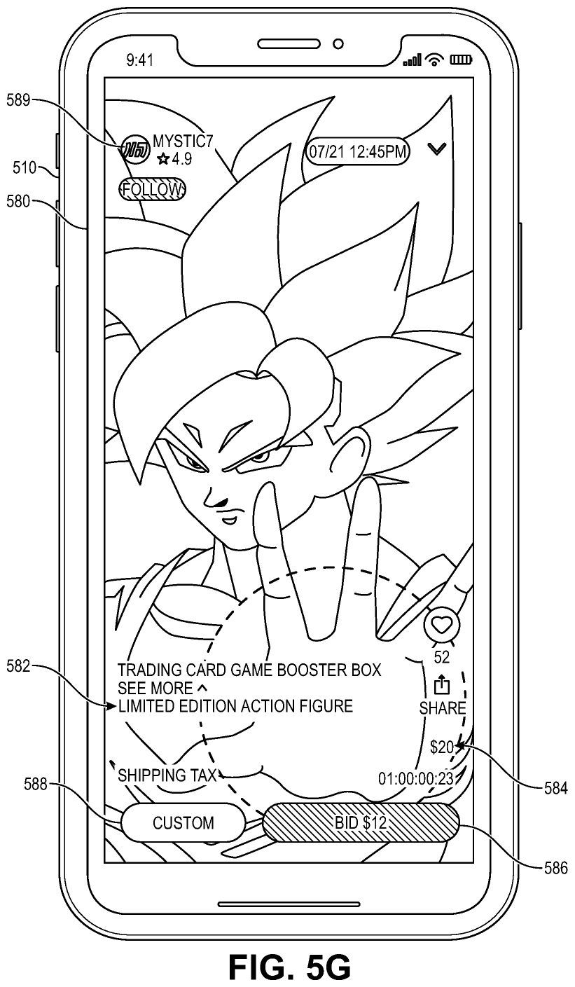

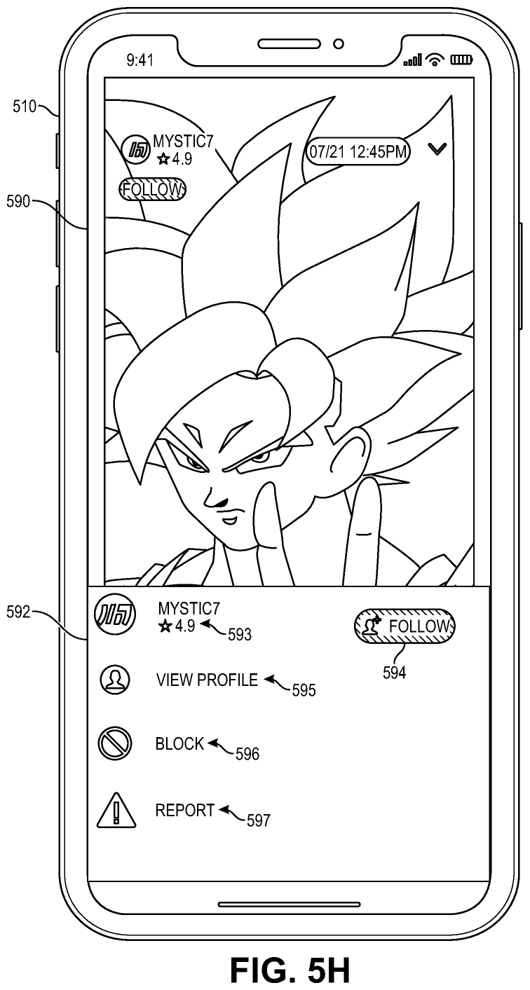

In any case, the buyer devices 204a, 204b, and 204c may access the posted story (240.1, 240.2, 240.3) while the story is active (i.e., within the limited duration of time provided that the seller has not deleted the story). Accessing the story at a buyer device 204a-204c, generally speaking, includes displaying the one or more images/videos (or at least a portion thereof) at the buyer device 204a-204c in conjunction with real-time information associated with the sale of the one or more items. If the story includes an auction of an item, accessing the story can include displaying real-time auction information (e.g., the most recent bid price for the item, time remaining in the auction), and/or placing a bid in the auction. Similarly, if the story includes an offer for direct purchase of an item, accessing the story displaying real-time purchase information (e.g., price, quantity remaining, etc.), and/or communicating with the auction server 224 to purchase the item. While the story remains active, the auction server 224 maintains real-time information associated with the auction or offer for direct purchase of the item, such that each buyer device 204a-204c accessing the story pulls real-time auction or purchase information from the auction server 224 associated with the item(s). Functionalities associated with accessing stories will be illuminated further in subsequent portions of the present description, particularly with respect to example GUIs illustrated in FIGS. 5A-5H. 6A-6D, 7A, and 7B.

After the “lifetime” of the posted story has elapsed, the story expires at the auction server 224 (242), and thus the story is no longer viewable publicly at the buyer devices 204a-204c. In embodiments, the auction server 224 may continue to store the story and make the expired story still visible to the seller device 202, within a dedicated story archive available to the seller. In some embodiments, expiration with the story coincides with conclusion of an auction for an item featured in the story, and accordingly, the auction server 224 may execute additional logic associated with concluding the auction (e.g., identifying the highest bid and bidder for the item, notifying a buyer device of the highest bidder for the item, facilitating shipment of the item and/or payment for the item based upon stored profile information of the highest bidder, etc.).

Although the process of FIG. 2 outlines just one posted story from a seller for the sake of simplicity, it should be envisioned that, in embodiments, a seller may have multiple stories active at any given time. For example, the seller device 202 might post a first story that includes an image/video with an auction for a first item, and subsequently, post a second story that includes an image/video with an offer for direct purchase of the second item, where each of the first and second stories have a lifetime of 24 hours. After both stories are posted, both the first and second story are simultaneously accessible via the seller's story view until the lifetime of 24 hours has elapsed since the posting of the first story (e.g., buyer devices 204a-204c may navigate between multiple stories of the same seller as will be described in subsequent portions of the present description). Once the first story has expired, only the second story remains accessible via the seller's story view, until the lifetime of the second story has elapsed and the second story expires. Effectively, a seller's story view can, at any given time, include one, two, three, or more stories, with the lifetimes, auction/purchase information, etc. being independently stored and managed via the auction server 224.

Subsequent sections of the present description include description of example GUIs illustrated in FIGS. 3A-3E, 4A-4I, 5A-5H, 6A-6D, 7A, and 7B. Generally speaking, the GUIs may be implemented at one or more electronic computing devices (e.g., mobile computing devices 110a, 110b, 202, 204a-204c, etc.), executing non-transitory computer executable instructions, which instructions may be part of a mobile software application as described in the present description (e.g., the seller application 114 and/or buyer application 116 of FIG. 1), and which may cause the one or more electronic computing devices to communicate with one or more servers (e.g., servers 128, 132, 134, 136, and/or 224). User interaction with the GUIs of the subsequent figures may be performed, for example, via touchscreen interactions, voice interactions, and/or other suitable input/output methods.

### Posting Images/Videos to User Profile as a Story

FIGS. 3A-3E illustrate example interactive GUIs associated with a seller creating and posting a story comprising one or more time-limited videos and/or images associated with one or more items to be made available for auction or for direct purchase. The GUIs of FIGS. 3A-3E are executed at a seller device 310, which may correspond for example to the seller device 202 of FIG. 2, the seller device 110a of FIG. 1, and/or another suitable device. The seller device 310 includes a camera 314 (i.e., at least one camera, e.g., a front-facing camera and/or a rear-facing camera), a microphone 316 (i.e., at least one microphone), and a visual display 318 (e.g., touchscreen) that displays the GUIs that will be described with respect to FIGS. 3A-3E. The GUIs described with respect to FIGS. 3A-3E may be implemented, for example, via the seller device executing the seller application 114 of FIG. 1, which may be in communication with the auction server 124 of FIG. 1, auction server 224 of FIG. 2, and/or other servers described herein.

Starting with FIG. 3A, the seller device 310 displays a first GUI 320 for creating a story, the GUI 320 displaying a home interface of the seller application. An overlay 322 is presented over the top of the home interface, with the overlay 322 being accessible, for example, by swiping upward from the bottom of the display 318 (and/or via other suitable user interactions). The overlay 322 provides interactive options 324, 326, and 328 respectively for scheduling a live auction event (324, “Schedule a Live Show”), creating a new item listing on the seller's profile (326, “Create new listing”) and creating a new story (328, “Create a Story”). In an example process, the user of the seller device 310 (“seller”) may select the create story option 328 to start creating a new story (e.g., via tapping the option 328 on the display 318, or via voice interaction or other suitable user interaction).

FIG. 3B illustrates another example GUI 330 for creating a story. The GUI 330 may be displayed, for example, in response to selection of the create story option 328 of FIG. 3A, and displays introductory information for the story features of the present description. The seller may dismiss the GUI 330 to proceed to subsequent GUIs for creating the story as described in this section (e.g., the user may tap the display 318 to dismiss the GUI 330). In some embodiments, where the seller is already familiar with the story featured described herein (e.g., the seller has already posted stories previously), the GUI 330 of FIG. 3B may be omitted (e.g., the process of creating the story may instead proceed directly from the GUI 320 of FIG. 3A to other GUIs to be described with respect to FIGS. 3C-3E).

Turning now to FIG. 3C, a GUI 340 displayed at the seller device 310 enables the seller to obtain one or more images to be included in a story. The image visible in FIG. 3C within the GUI 340 may correspond to a current view frame of the device camera 314, with an icon 342 that may be selected to cause the device camera 314 to capture an image. Alternatively to capturing an image via the icon 342, the seller may select an icon 344 to open a gallery of images and/or videos stored at the seller device 310, e.g., to select an image or video previously downloaded from the Internet or obtained by the seller device 310 via other means. The GUI 340 further includes an icon 346 that may be selected to flip the camera of the seller device 310, e.g., to switch between use of a front-facing camera and a rear-facing camera of the seller device 310.

Similarly to the image capturing GUI of FIG. 3C, FIG. 3D illustrates a GUI 350 for capturing a video, where tapping and holding an icon 352 causes the device camera 314 to capture a video (e.g., for as long as the icon 352 is held, up to a maximum video length which may for example be ten seconds, fifteen seconds, 30 seconds, etc.). In some embodiments, the functionalities of the GUIs of FIGS. 3C and 3D are combined. For example, the icon 342 of FIG. 3C and icon 352 of FIG. 3D may be a same icon, where tapping and releasing the icon causes the device camera 314 to capture an image, whereas tapping and holding the icon causes the device camera 314 to capture a video.

FIG. 3E illustrates an example GUI 360 that the seller device 310 may display once at least a first image or video has been obtained. The GUI 360 displays the obtained image or video, with a “Create Story” option 362 to add the obtained image/video to a new story. Additionally, an “Add Product” option 364 is may be selected to enable the seller to add one or more items to be associated with the one or more images and/or videos in the story. Selecting the add product option 364 may direct the seller device 310 to additional GUIs for adding and/or selecting items, with examples of such GUIs being described in the following section of this description with respect to FIGS. 4A-4I.

Associating an Item with a Story

FIGS. 4A-4I illustrate example GUIs that may be displayed via the display 318 of the seller device 310, these GUIs generally enabling the seller to associate the story with one or more items from an inventor of the seller (i.e., a current inventory associated with a unique user profile of the seller). The GUIs of FIGS. 4A-4I may be displayed, for example, by the seller device 310 executing the seller application 114 of FIG. 1.

First, FIG. 4A illustrates an example item inventory GUI 410 that may be accessed, for example, by the seller selecting the “Add Product” option 364 from FIG. 3E. The item inventory GUI 410 displays an inventory of items that have previously been added to the seller's unique user profile, the inventory including a first item 412, a second item 414, and a third item 416. The GUI 410 provides, of the respective items 412, 414, and 416 an “Add to Story” option 418 that may be selected to associate the respective item with the story (e.g., to make the item available for direct purchase via the story, or to offer the item for auction within the story, as will be described later). The seller may scroll upward or downward (e.g., via touchscreen interactions) and/or utilize one or more filter controls 419 to further explore the item inventory. FIG. 4B illustrates an example user interface 420 presented at the seller device 310 responsive to the seller selecting one of the options 418 in FIG. 4A. Replacing the selected option 418 from FIG. 4A is an indicator 422 that informs the seller that the item was added to the story. Additional controls in the GUI 420 enable the seller to either confirm the selection of the item (424) or cancel the selection of the item (426).

FIG. 4C illustrates a GUI 430 that the seller device 310 may alternatively display, for example, if the seller's item inventory is empty at the time of seller selecting the “Add Product” option 364 from FIG. 3E. The GUI 430 presents an icon 432, which can be selected to add an item to the seller's inventory which will, in turn, be added to the story. In some embodiments, the icon 432 can be included in the GUIs of FIGS. 4A and/or 4B, i.e. to enable the seller to either select an existing item from the item inventory or add a new item.

FIGS. 4D and 4E illustrate an example GUI 440 via which the seller may add an item to their inventory, to in turn be added to the story from FIGS. 3A-3E. Specifically, FIG. 4D illustrates a first portion 445 of the GUI 440, and FIG. 4E illustrates a second portion 450 of the GUI 440. The seller can navigate between the portions 445 and 450, for example, via touchscreen scrolling and/or other user interaction at the seller device 310. The GUI 440 may be displayed at the seller device 310, for example, upon selection of the icon 432 from FIG. 4C. Alternatively, in some embodiments, the GUI 440 may be displayed automatically based upon a determination that the seller's item inventory is empty at the time of creating a story (e.g., a process for adding an item may proceed directly from the add product option 364 of FIG. 3E to the GUI 440.

Referring to FIG. 4D, the GUI 440 includes fields 442 and 444 via which the seller may designate primary and secondary categories (respectively) for the item. Categories defined for an item can include, for example, “trading cards,” “sports,” “toys,” “digital assets,” “comics and books,” “sneakers and streetwear,” “vintage and thrift items” “video games,” “miscellaneous,” etc., with subcategories for each category (e.g., for different types, brands, etc. in a same category). A “recently used” section 446 enables the seller to choose from recently used category/subcategory combinations, as an alternative to using the fields 442 and/or 444. Designation of categories may be used, for example, to determine which stories from which sellers may be displayed most prominently to certain buyers in the buyer application of the present description (e.g., stories may be displayed to a buyer if the buyer has previously “followed” the same category, or viewed or purchased items in the same category).

Moving to the portion 450 of the GUI 440 as illustrated in FIG. 4E, a field 452 is provided for entering the name of the item being added. If the seller application operating at the seller device 310 determines that the item is already known (e.g., via communications with an item catalogue server), additional fields in the GUI 440 may be automatically pre-filled with known information about the item (e.g., category/subcategory, description, shipping weight, recommended pricing information, etc.). In any case, the GUI 440 further includes a field 455 to add a price for the item (e.g., a price for the item via direct purchase through the story, or an initial auction price for the item to be auctioned within the story), and a field 456 to add a shipping weight for the item. Still additionally, the GUI 440 includes an option 457 to add one or more additional photos, which can for example be used within the story, and/or may be stored in association with the item such that the added photo(s) are usable in subsequent stories that relate to the same item. Once all required fields are completed, an option 458 allows the item to be added to the story, or alternatively, an option 459 cancels the addition of the item. If the added item is previously unknown to the seller application, the seller application may cause the added item to be added to the item catalogue associated with the seller application (e.g., via communication with one or more servers).

FIGS. 4F and 4G illustrate another GUI 460 for adding an item. The GUI 460 is similar to the GUI 440 of FIGS. 4D and 4E, but includes some fields in both portions 465 (FIG. 4F) and 470 (FIG. 4G) of the GUI 460 populated with information regarding an item. For example, a name field 466 is populated, e.g., based upon manual entry by the seller and/or based upon communications with an item catalogue server (e.g., server 132 of FIG. 1) to look up the item name stored by the server. In some embodiments, in response to entering the name in the name field 466, fields 462, 464, and/or 468 may automatically be populated based upon known information regarding the item. Turning to FIG. 4G, the seller may use fields 472 to input price and shipping information for the item, respectively. Upon completing the fields in the GUI 460, the seller may select a “next” option 476 to confirm adding the item to the story.

FIG. 4H illustrates an example GUI 480 that may be displayed by the seller device 310 once the seller has added an item to be sold via the story. Preview fields 482 and 485 prompt the seller to include images both of a front side of the item (482) and a back side of the item (484). The GUI 480 further indicates that still other photos/videos may be added (485). Similarly to in FIGS. 3C and 3D, the seller may add another photo/video a capture icon 487 and/or via an image/video gallery icon 488, which may summon images/videos stored on the seller device 310 and/or in the item catalogue server accessed via the seller application. Once finished adding photos/videos, the seller 489 may select a “complete” option 489 to indicate that all desired photos/videos have been obtained for the item associated with the story.

Finally, FIG. 4I illustrates an example GUI 490 that displays a preview of the story that may be shown to the seller upon completion of the previous actions described in this section. The story preview GUI 490 represents how the story may look upon being viewed by a buyer, with the GUI 490 displaying at least one photo or video of the item in conjunction with information associated with at least one of the one or more items (492). The GUI 490 further includes an option 494 to enable or disable audio to be played via the story, and an option 496 that enables one or more users to be “tagged” in the story. Selection of a “Create Story” option 498 causes the story to be added to the story view of the seller's unique user profile (e.g., by posting the story to an auction server 224 which hosts the story for access by buyer devices). Example GUIs for accessing and displaying the story will be described with respect to FIGS. 5A-5H.

### Auction of an Item Via a Story

FIGS. 5A-5H illustrate example GUIs associated with accessing one or more stories featuring one or more items for auction, and bidding on the one or more items within the story, bidding on an item featured in a story, and/or directly purchasing an item featured in a story. The GUIs of FIGS. 5A-5H may be displayed, for example, by the display 518 of the buyer device 510 executing the buyer application 116 of FIG. 1.

First, FIG. 5A illustrates an example home GUI 520 via which the user of the buyer device 510 (“buyer,” i.e., a person or entity potentially bidding on or purchasing one or more items featured in a story) may access stories posted by one, two, three or more sellers (i.e., persons/entities posting stories to their respective story views for purposes of selling items). The GUI 520 displays story indicators 522, 523, 524, and 525 indicating that respective sellers, identified by unique profile names under the respective story indicators, each have one or more active stories viewable by the buyer. Each of the story indicators 522, 523, and 524 includes a brightened peripheral ring 526 (which may be, for example, a prominently-colored purple, green, blue, or red-colored ring), which serves as an indication that at least one of the stories from the respective seller is a “new” story that the buyer has not yet viewed. Alternatively, in the case of the story indicator 525, a dull peripheral ring 527 (e.g., a gray-colored ring) indicates that the seller has at least one active story but that the buyer has already viewed all active stories from the seller. Stories provided by the GUI 520 may be tailored or sorted for the user based on, for example, sellers the buyer “follows,” sellers with whom the buyer frequently engages (e.g., by buying or bidding on items and/or by viewing stories), sellers with new stories, or some combination of these and/or additional factors. In any case, the buyer may interact with a story indicator (e.g., via touchscreen taps and/or other interactions) to view stories posted by a given seller, e.g., beginning with an oldest “new” story posted by the seller (or, if no stories from the seller are new, with the oldest active story from the seller).

Still referring to FIG. 5A, the GUI 520 further includes a navigation area to navigate to categories of items followed by the buyer, a watch list of live auction events for the buyer, and a bottom navigation menu 528. The bottom navigation bar 528 includes an illuminated “home” icon 529 indicating the home GUI 520 is the active interface in the application.

FIG. 5B illustrates another example home GUI 530. Compared to the GUI 520 of FIG. 5A, home interface functionalities of the GUI 530 are reorganized to display recommended live auction events near the top of the GUI 530, with story indicators 532, 534, and 536 below operating in a manner similar to the story indicators described above with respect to FIG. 5A.

FIGS. 5C and 5D illustrate an example GUI 540 that displays a unique user profile of a seller, who is identified by a unique username 541. Specifically, FIG. 5C illustrates a first portion 545 of the GUI 540, and FIG. 5D illustrates a second portion 550 of the GUI 540. The buyer may navigate between the first and second portions 545 and 550 by scrolling up or down in the interface 540 (e.g., via a touchscreen swipe). Beginning with the first portion 545 in FIG. 5C, the profile GUI 540 includes a story indicator 542 including a brightened peripheral ring 544 indicating that the user 541 has one or more new stories not yet viewed by the buyer. The buyer may select the story indicator 542 to view the story view of the user 541, in a manner similar to that described with respect to FIGS. 5A and 5B.

The profile GUI 540 of FIG. 5C further includes “buyer” and “seller” options 546 and 547, respectively, which can be used to alternate between buyer and seller views of the user 541. Selecting the “seller” option 547 may cause the profile GUI 540 to display activity of the user 541 as a seller, as shown in FIG. 5C for example to include one or more live auction events (“Shows”) scheduled or previously conducted by the user 541. Alternatively, selecting the “buyer” option 546 may cause the profile GUI 540 to display activity of the user 541 as a buyer, e.g., items the user 541 has directly purchased or for which the user 541 has won an auction, or one or more live auction events in which the user 541 has participated. Effectively, the user 541 may operate as both a buyer and a seller, with the story view of the user 541 in particular featuring activities of the user 541 as a seller. Continuing to FIG. 5D, the second portion 550 of the GUI 540 includes an item listing 552 from the item inventory of the user 541. The navigation bar 528 includes an illuminated icon 526 indicating that the buyer is viewing the user profile (the buyer can, for example, select the previously-described “home” icon in the navigation bar 528 return to the home GUI of FIG. 5A and/or 5B).

FIG. 5E illustrates an example GUI 560 displaying a story in the story view of a seller (e.g., in response to selection of a story indicator as described in FIGS. 5A-5D). The GUI 560 displays at least one image or video 562 from among the one or more images and/or videos included in the story, in conjunction with information relating to sale of one or more items. The information includes a name and description 563 of an item, and a price 564 of the item (in this case, a current auction price). The GUI 560 identifies a most recent (i.e., current) bid price 564 of the item, and provides an option 566 to place a bid, as will be described with respect to subsequent figures. The GUI 560 further includes a profile field 567 of the seller, and a “follow” option 568 to follow future stories, live auction events, etc. of the seller. Finally, a date/time indicator 569 indicates the date and time at at which the auction is scheduled to end (or, additionally or alternatively, the date/time at which the seller posted the story).

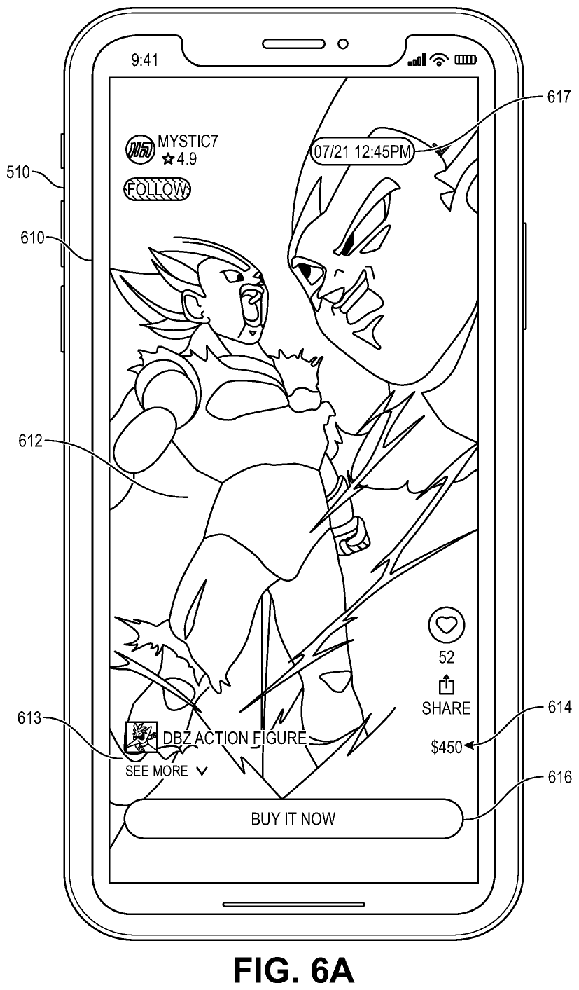

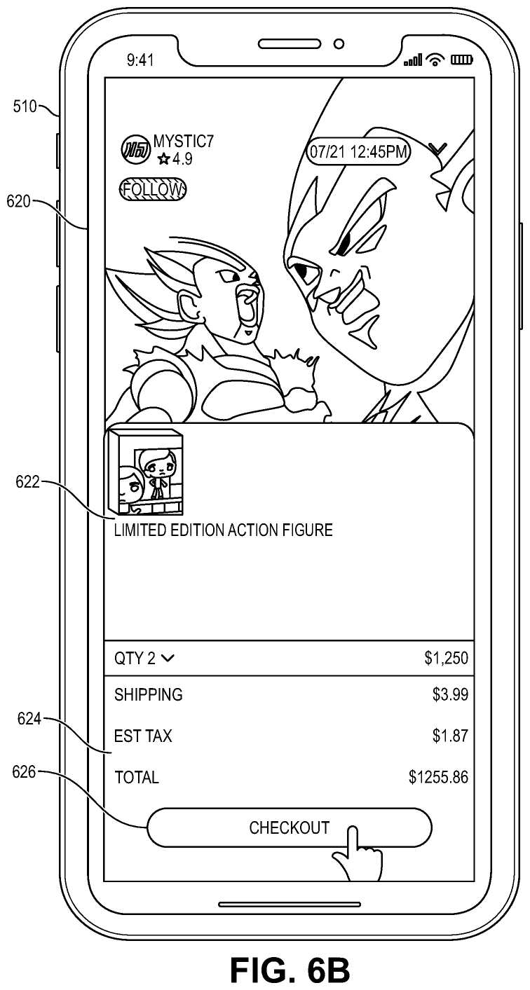

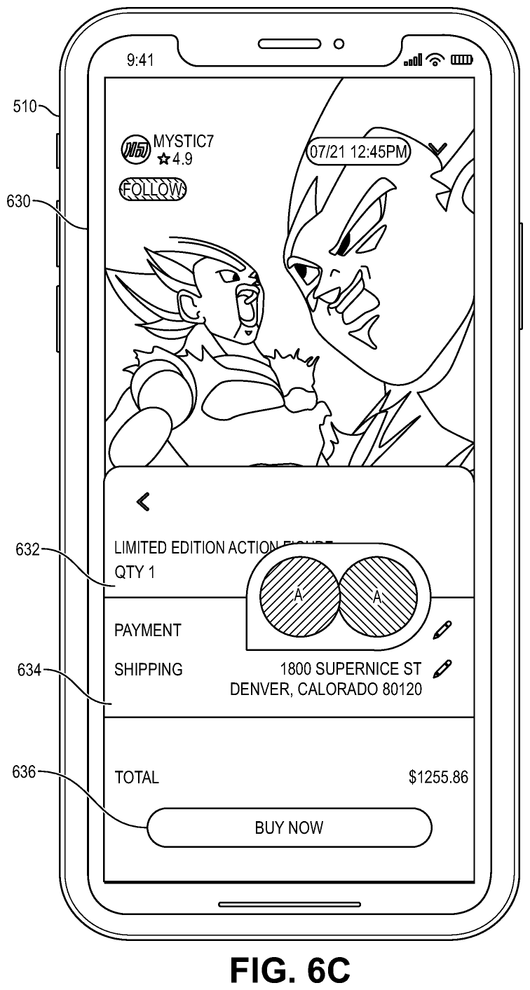

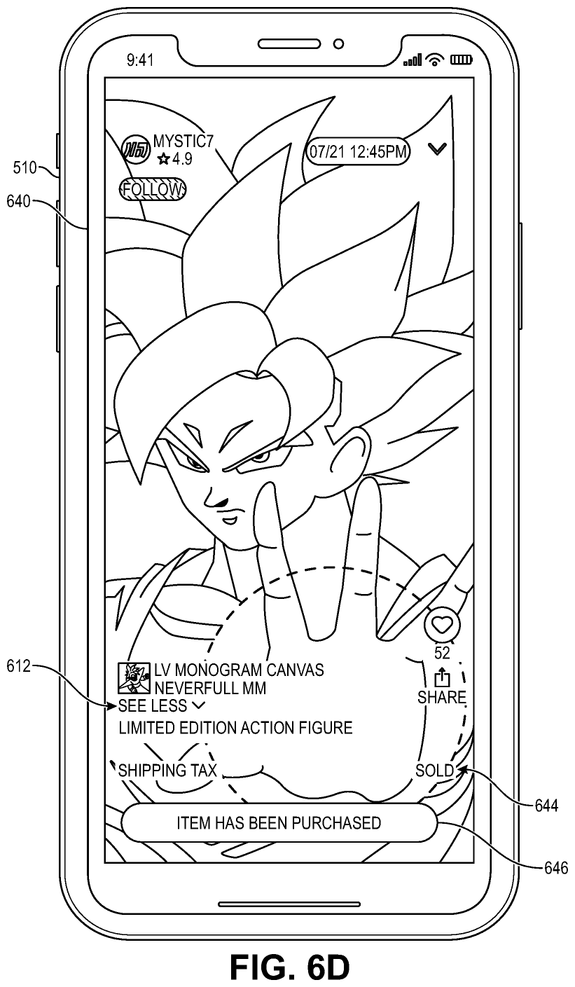

In embodiments, the buyer may interact with the GUI 560 to navigate between two or more images and/or videos included in the story, or between multiple active stories from the seller. For example, the buyer may swipe left or tap the left side of the display 518 to navigate to a previous image/video from the same story, or to a previous story from the seller. Similarly, the buyer may swipe right or tap the right side of the display 518 to navigate to a next image/video in the same story, or to a next story from the seller. In some embodiments, the GUI 560 automatically progresses the buyer through the seller's stories (e.g., by advancing forward after viewing a still image for a predetermined amount of time or after completing a video). Tapping and holding a location on the display 518 may pause to prevent automatically advancing through the story. Furthermore, other user interactions to bid on or purchase the item (e.g., opening interfaces that will be described with respect to FIGS. 5F-5H and 6A-6D) may similarly prevent automatically advancing through the story. If the buyer has navigated past the final story in the seller's story view (i.e., the most recently posted story), the GUI 560 may return the buyer to a previous interface accessed by the buyer (e.g., a home interface or user profile from which the buyer accessed the seller's story view).

As the buyer navigates between one, two, three or more images and/or videos of a same story, the item name and description 563, price 564, and bid option 566 remain displayed. Moreover, the item name and description 563 and price 564 may be automatically updated at the GUI 560 in real-time (e.g., to reflect the most recent bid posted to the auction server from another buyer device, or updates to the item information by the seller). Real-time updating of these fields may be enabled, for example, via the auction server (e.g., server 124 or 224) automatically communicating with the buyer device 510, e.g. by implementing a publish/subscribe channel that connects the buyer device 510 to automatically receive updates for the viewed story while the buyer views the story. Further detail regarding implementation of a publish/subscribe channel via an auction server is provided in U.S. Pat. No. 11,196,577.

FIG. 5F illustrates an example bidding GUI 570 that the buyer device 510 may display, for example, in response to the buyer selecting the option 566 from FIG. 5E. The GUI 570 includes a bidding panel 572 overlaid over the GUI 560 from FIG. 5E. The bidding panel 572 includes a time indicator 573 counting down the time remaining in the auction, and a bid field 574 for the buyer to enter a bid. The bid field 574 is defaulted to include the lowest amount that the buyer may successfully bid in view of the real-time status of the auction (i.e., the previous highest bid, plus any required increment between bids). Controls 575 and 576 are provided to increment the bid field 574 upward or downward, respectively. The bid panel 572 further includes an option 577 to confirm the bid, and an alternate option 578 to cancel the bid and return to the GUI 560 of FIG. 5E. Similarly to the item information in FIG. 5E, the information in the bidding panel 572 is updated in real-time (e.g., to prevent the buyer from entering a bid in the field 574 that is less than a bid that was placed since the buyer accessed the interfaces 560 and/or 570. Upon the buyer placing a bid at the seller device 510, other buyer devices presently viewing the story may receive the updated bidding information in real-time at their respective devices (e.g., via publish/subscribe-based communications with the auction server hosting the story).

FIG. 5G illustrates an alternate GUI 580 displaying a story featuring an auction of an item. Similarly to the GUI 560 of FIG. 5E, the GUI 580 includes a name and description 582 about the item, and a current bid price 584. In this instance, a bid option 586 can be selected to cause the buyer to place a bid for a predetermined amount, e.g., the minimum next bid amount in view of the real-time status of the auction. Alternatively, the buyer can select a “custom” option 588 to place a bid of a user-defined amount, e.g., via the GUI 570 of FIG. 5F. The GUI 580 further includes a profile field 589 of the seller (e.g., displaying the seller's username, profile photo, seller rating, etc.).

FIG. 5H illustrates another example GUI 590 that may be displayed, for example, in response to the buyer selecting the profile field 589 of FIG. 5G (or the similar profile field 567 of FIG. 5E). The GUI 590 of FIG. 5H overlays a user information panel 592 on top of the GUI 580 from FIG. 5G. The user information panel 592 includes profile information 593 of the seller (e.g., username, profile photo, rating, etc.) and an option 594 to follow the seller. The user information panel 592 further includes an option 595 to view the profile of the seller (e.g., as shown in FIGS. 5C and 5D), an option 596 to block the seller to stop seeing stories, items, etc. from the seller, and an option 597 to report misconduct by the seller.

### Direct Purchase of an Item Via a Story

FIGS. 6A-6D illustrate example GUIs associated with directly purchasing one or more items featured in a story (i.e., without an auction). The GUIs of FIGS. 6A-6D may be displayed, for example, by the buyer device 510 executing the buyer application 116 of FIG. 1. In embodiments, the GUIs of FIGS. 6A-6D can be accessed in a similar manner to the auction-based GUIs of FIGS. 5E-5G (e.g., via selection of a story indicator as described with respect to FIGS. 5A-5D). Where illustrated in FIGS. 6A-6D, similar controls, icons, fields, etc. may operate in a manner similar to that described above with respect to FIGS. 5A-5H, unless indicated otherwise.

First, FIG. 6A illustrates an example GUI 610 displaying a story from a seller, the story featuring an item for direct purchase within the story. The GUI 610 displays at least one image or video 612 from among the one or more images and/or videos included in the story, in conjunction with information relating to the direct purchase of the item. The information includes a name and description 613 of an item, and a price 614 of the item. The GUI 610 further displays an option 616 that the buyer can select to buy the item at the indicated price 614. The GUI 610 still further includes a date/time indicator 617, which indicates the date and time at which the story is to expire (or alternatively, the date/time at which the seller posted the story). In some embodiments, the featured item may remain available for purchase via the seller's profile after the indicated date/time, while the story itself featuring the item is no longer active in the seller's story view. Item information in the GUI 610 may be updated in real-time, for example, to reflect a change in the available quantity of the item due to activity from other buyers, or due to a change to the item information by the seller.

Moving to FIG. 6B, a direct purchase GUI 620 may be displayed at the buyer device 510, for example, in response to selection of the option 616 from FIG. 6A. The direct purchase GUI 620 includes a direct purchase panel 622 overlaid on top of the GUI 610 from FIG. 6A. The direct purchase panel includes item pricing information 624 and a checkout option 626 to proceed with the direct purchase.

Moving next to FIG. 6C, a payment and shipping GUI 630 may next be displayed at the buyer device 510, for example, in response to selection of the checkout option 626 from FIG. 6B. The payment and shipping GUI 630 includes a payment and shipping panel 632 overlaid on top of the GUI 610 from FIG. 6A. The panel 632 includes payment and shipping information 634 which may be automatically populated, for example, in response to stored user profile information regarding the buyer. The panel 636 includes an option 636 to confirm the purchase of the item. Upon confirmation of the purchase, the seller may be automatically notified of the purchase. In some embodiments, the auction server causes a label to be generated and sent to the seller e.g., based upon the shipping information of the buyer.

FIG. 6D illustrates an example GUI 640 that the buyer device 510 may display when the item featured for direct purchase in the story has already been bought (e.g., by the same buyer after completing the purchase, or when all available quantity of the item was bought by another buyer(s)) While the same item information 612 from the GUI 610 of FIG. 6A remains visible, indicators 644 and 646 indicate the previous sale of the item instead of offering the viewer the opportunity to purchase the item. This information in the GUI 640 is updated in real-time in the seller's story based upon the status of the item. For example, the information displayed in the story as first posted may resemble the GUI 610 of FIG. 6A in that purchase of the item is enabled, while the story may later change to resemble the GUI 610 of FIG. 6D when the item has been purchased before the end of the lifetime of the story. In some embodiments, the story is automatically removed from the seller's story view if no remaining quantity of the item remains.

### Modifying or Removing a Story

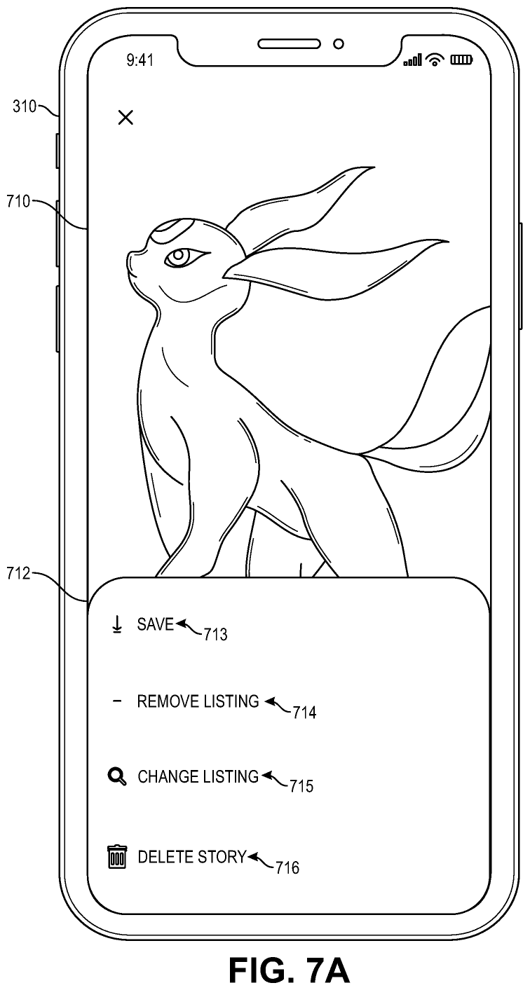

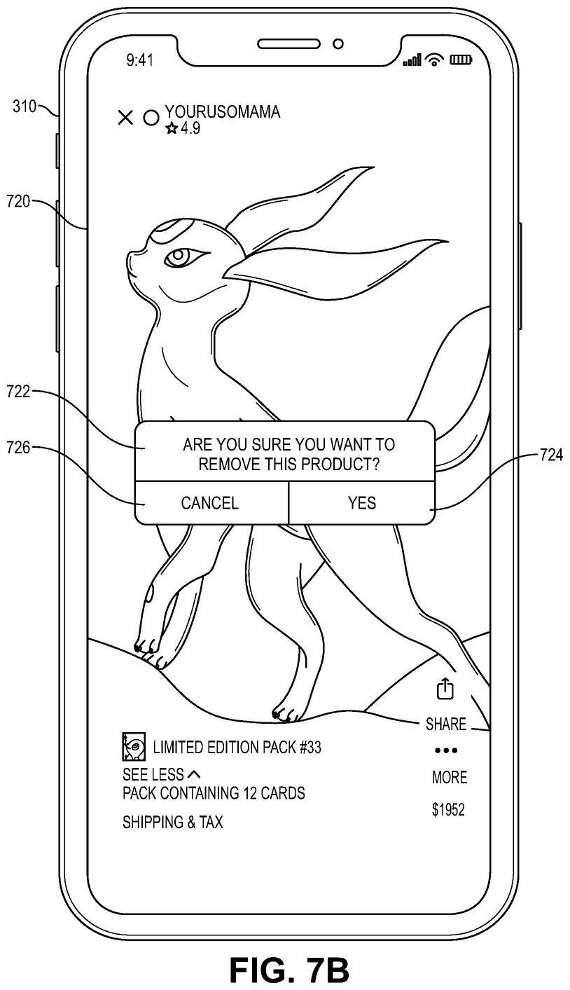

FIGS. 7A and 7B illustrate example GUIs for a seller using the seller device 310 to delete a story from the seller's story view or modify an item listing associated with the story.

FIG. 7A illustrates a first GUI 710 including a panel 712 overlaid on top of the seller's story as viewed at the seller device 310. The seller may access the panel 712, for example, by swiping upward from the bottom of the screen while the seller's own story. The panel 712 includes an option 713 to save the story (e.g., the associated one or more images and/or videos) to local memory of the seller device 310. The panel 712 further includes an option 714 to remove the item listing from the story (i.e., to remove the association of the item for auction or direct purchase, while leaving the one or more images/videos of the story). Still further, the panel 712 includes an option 715 to change the item listing featured in the story (e.g., to change item description information, pricing, etc., for example as described with respect to FIGS. 4E-4G). Finally, the panel 716 includes an option 716 to delete the story altogether (i.e., to cause the story to be removed from the seller's story view, including the one or more images/videos, such that buyers can no longer see the story when viewing the seller's story view).

FIG. 7B illustrates a second GUI 720 usable to confirm removal of the item listing from the story and/or deletion of the story (e.g., based upon selecting one of the options 715, 716, or 717 from FIG. 7A). A panel 722 includes an option 724 to confirm removal of the item, and an option 726 to cancel removal of the item.

### Example Mobile Computing Device and Server

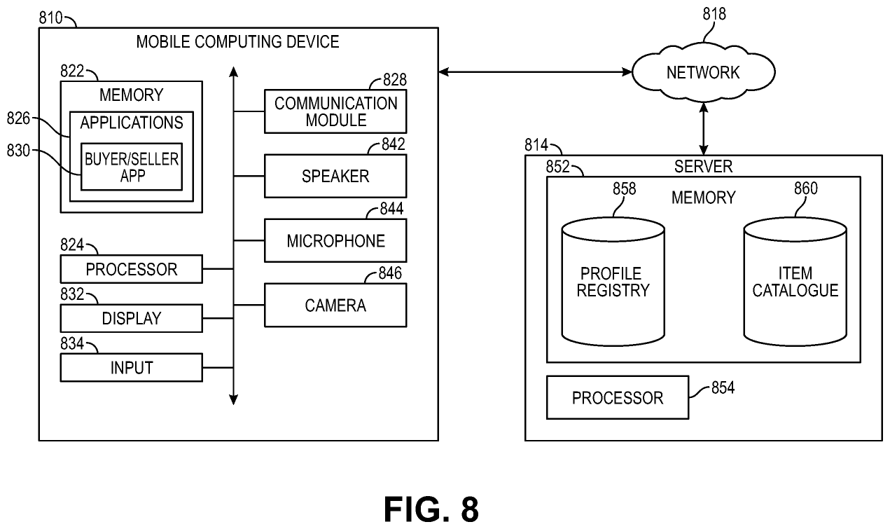

FIG. 8 illustrates a block diagram of example components of a mobile computing device 810 and a server 814 communicating over a network 818, in accordance with embodiments of the systems and methods described herein. The mobile computing device 810 may correspond, for example, to any of the mobile computing devices of the present description (e.g., the seller device 110a, 202, or 310, the buyer device 110b, 204a, 204b, 204c, 510, etc.). The server 814 may correspond, for example, to the auction server 124 and/or 224, and/or to another one or more servers of the present description. The mobile computing device and/or server 814 may include additional, fewer, or alternate components to those described in this section, in various embodiments. Additionally, in some embodiments, the mobile computing device 810 may be substituted for another computing device(s), e.g., a desktop computer or laptop computer.

The mobile computing device 810 may include a memory 822, which may include one or more non-transitory memories (e.g., ROM) and/or one or more volatile memories (e.g., RAM). In particular, non-transitory portions of the memory 822 may store non-transitory, computer executable instructions that are executable by a processor 824 (i.e., one or more processors) to cause the mobile computing device 810 to perform actions described in this detailed description. Non-transitory portions of the memory 822 may include one or more applications 826. Each respective application 826 may include one or more sets of non-transitory computer executable instructions that, when executed by the processor 824, cause the mobile computing device 810 to perform operations associated with the respective application 826 (e.g., operations involving the processor 824, a communication module 828, and/or other components of the mobile computing device 810 discussed herein). The one or more applications may include an auction application 830 (“Buyer/Seller App”) usable to access live auction events and/or post/access stories as described herein.

The mobile computing device 810 may include a display unit 832 (i.e., one or more display devices, such as a touch-enabled visual display (“touchscreen”) or other visual display). The mobile computing device may further include an input unit 834 (i.e., one or more user input devices, e.g., a touchscreen or touchpad, a keyboard, a mouse, etc.). In some embodiments, aspects of the display unit 832 and 834 are integrated (e.g., as a touchscreen with both touch input and display capability). The display unit 832 and/or the input unit 834 may be physically included within the mobile computing device 810 (e.g., a fixedly installed touchscreen), or may be operatively coupled with the mobile computing device 810 by other means (e.g., a peripheral touch pad, mouse, keyboard, etc. connected to the mobile computing device 810 by wired and/or wireless means).

The mobile computing device 810 may include a speaker 842, a microphone 844, and/or a camera 846. In some embodiments, the mobile computing device 810 may include still other sensor components, e.g., a positioning unit (e.g., GPS), an accelerometer, a gyroscope, etc. The speaker 842, microphone 844, camera 846, and/or other sensor component(s) may be physically included within the mobile computing device 810 (e.g., a natively installed speaker, microphone, or camera), and/or may be operatively coupled with the mobile computing device 810 by other means (e.g., a peripheral camera, speaker, or microphone connected to the mobile computing device 810 by wired and/or wireless means).

Collectively, the display unit 832, input unit 834, speaker 842, microphone 844, camera 846, and/or other sensing component(s) may provide one or more user interfaces of the mobile computing device 810. For example, the display unit 832 may display/present one or more graphical user interfaces (GUIs) which may include interactive controls that the user of the mobile computing device 810 can activate via the input device 834 to cause functionalities described herein to be performed (e.g., via a touchscreen tap or swipe, a mouse click, a keyboard stroke, etc.). Additionally or alternatively, in some embodiments, similar user interfaces may be provided at least partially by the speaker 842, microphone 844, camera 846, and/or other sensing components of the mobile computing device 810 (e.g., an interactive audio interface, a gesture-based user interface, or a user interface responsive to physical movement of the mobile computing device 810). In some embodiments, a user of the live auction application 830 at the mobile computing device 810 may configure device permissions defining components of the mobile computing device 810 the live auction application 830 may use to provide GUIs, provide notifications, and/or perform other functionalities.

The server 814 (i.e., one or more servers, e.g., the auction server 124 and/or other servers of FIG. 1) include a memory 852, which may include one or more non-transitory memories (e.g., ROM) and/or one or more volatile memories (e.g., RAM). In particular, non-transitory portions of the memory 852 may store non-transitory, computer executable instructions that are executable by a processor 854 (i.e., one or more processors) to cause the mobile computing device to perform actions described in this detailed description. Non-transitory portions of the memory 852 may include, for example, one or more applications containing non-transitory instructions for controlling logic and communications relating to live auction events, user profiles, posting of stories to user profiles, auctioning or purchasing items via stories, etc. The memory 852 may further include one or more APIs configured to control communications between the server 814 and the mobile computing device 810. Still additionally or alternatively, the memory 852 may store a profile registry 858, which may store various information described herein as relating to user profiles and stories posted to user profiles. Still yet additionally or alternatively, the memory 852 may store an item catalogue 860, e.g., defining known items available to be associated with stories (e.g., as described with respect to the item catalogue server 132 of FIG. 1).

The network 818 may include any suitable one or more communications networks, e.g., the Internet, a wired or wireless local area network (LAN), etc. Communications over the network 818 may include communications according to any suitable one or more communications protocols, including for example a mobile cellular communications protocol (e.g., CDMA, GSM, EV-DO, LTE, IP, etc.), one or more IEEE 802.11 protocols (e.g., Wi-Fi), Bluetooth, and/or other suitable protocols in accordance with the computing capabilities of the mobile computing device 810 and/or the server 814.

Various additional or alternative computing elements may be envisioned, in various embodiments. In particular, it should be understood that the server 814 may communicate over the network 818 with many mobile computing devices 814, e.g., belonging to various combinations of sellers and/or buyers.

### Example Computer-Implemented Methods

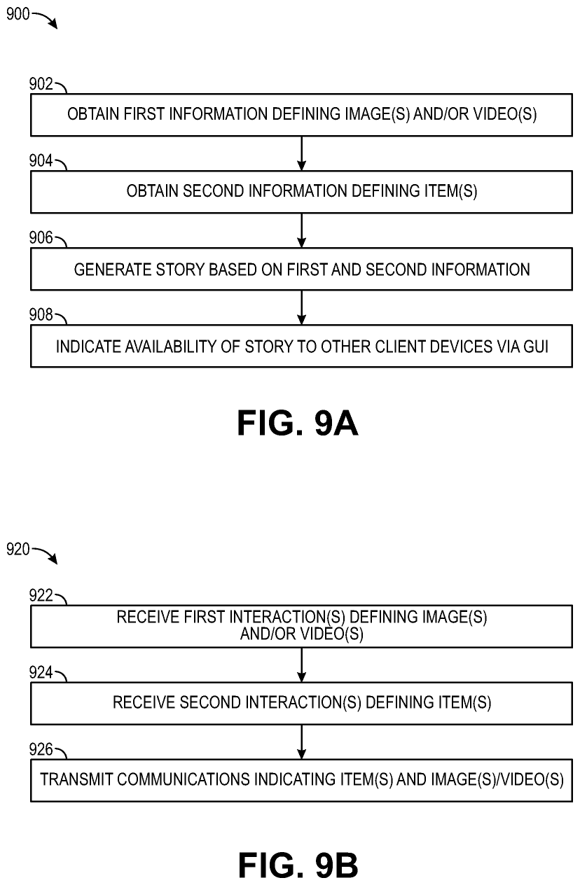

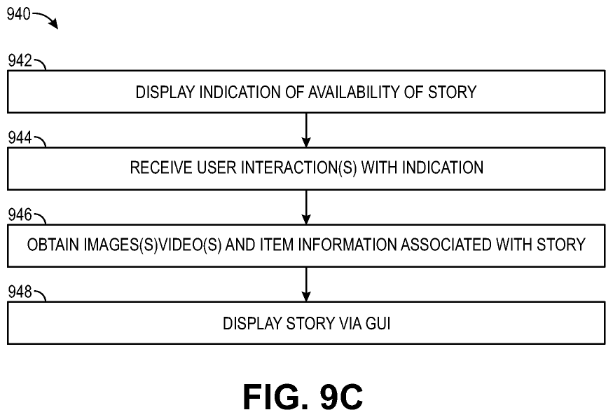

FIGS. 9A-9C illustrate block diagrams of example computer-implemented methods that may be performed by computing devices of the present description. At a high level, the methods of FIGS. 9A-9C relate to implementation of story features of the present description, e.g., posting stories from a seller device to one or more servers, providing access to stories via the one or more servers, and accessing stories via one or more seller devices.

In various embodiments, one or more memories of a computing device may store non-transitory, computer executable instructions that, when executed via one or more processors of the computing device, cause the computing device to perform actions of the computer-implemented methods described herein. Furthermore, in some embodiments, one or more non-transitory computer readable media may be provided (e.g., a non-removable computer memory, a removable flash drive, etc.), the one or more non-transitory computer readable media storing instructions that, when executed by one or more computing devices, cause the one or more computing devices to perform actions of the methods described herein. Order of actions of the methods described in this section vary from the order illustrated, and actions of the methods may be combined and/or substituted with other actions described in this detailed description, in various embodiments.

First referring to FIG. 9A, a computer-implemented method 900 is provided. The method 900 may be performed, for example, via a server (i.e., one or more servers, e.g., the auction server 124 and/or other servers of FIG. 1, and/or the auction server 224 of FIG. 2) in communication with a one or more client computing devices (e.g., seller and/or buyer mobile computing devices described herein) via a network (i.e., one or more networks).

The method 900 includes obtaining, from a first client computing device operating on behalf of a first user, first information defining one or more images or videos to be included in a time-limited social post (902, a “story”). In some embodiments, the first information includes the one or more images or videos themselves, where the one or more images or videos were previously captured or stored by the first client computing device. Additionally or alternatively, in some embodiments, the first information may include a selection of one or more images or videos stored by the one or more servers.

The method 900 further includes obtaining, from the first client computing device, second information defining one or more items to be made available for sale in association with the time-limited social post, the one or more items being associated with an inventory of a unique user profile associated with the user (904). In some embodiments, the second information includes a selection of one or more items previously added to the item inventory associated with the unique user profile of the first user. Additionally or alternatively, in some embodiments, the second information includes information defining a new one or more items to be added to the item inventory associated with the first user. In these instances, the method 900 may further include adding the new one or more items to the item inventory associated with the unique user profile of the first user.

The method 900 still further includes generating the time-limited social post based upon the first and second information (906). Generating the time-limited social post may thereby make the post available to be viewed, via the one or more servers and for a limited duration of time, at each of a plurality of second client computing devices.

The method 900 still yet further includes causing an indication of availability of the time-limited social post to be displayed via a first graphical user interface (GUI) at each of the plurality of second client computing devices (908). User interaction with the indication via the first GUI at a particular client device from among the plurality of second client computing devices may cause the particular client device to display the time-limited social post by displaying the one or more images or videos in conjunction with real-time information associated with the sale of the one or more items.

In some embodiments, the indication of the availability of the time-limited social post presented via the first GUI is a first indication from among a plurality of indications displayed via the first GUI, each of the plurality of indications respectively indicating a time-limited social media post being available from different respective users from among a plurality of users. That is, many sellers may post stories and the potential buyer may navigate among the respective story views of the many sellers.

The method 900 may include additional actions, in some embodiments. Particularly, in embodiments, the method 900 may include, via communications with the particular client device from among the plurality of client computing devices, and responsive to the interaction with the indication, causing the particular client device to display a second GUI to display the time-limited social post. The second GUI may enable the particular client device to participate in the sale of the one or more items while displaying the one or more images or videos in conjunction with real-time information associated with the sale of the one or more items.

In some embodiments, the method 900 still further includes, via communications with the particular client device, and responsive to a second one or more user interactions received via the second GUI at the particular client device, cause the particular client device to display a further one or more time-limited social posts associated with the first user, wherein displaying each of the further one or more time-limited social posts comprises displaying a respective one or more images or videos in conjunction with real-time information associated with a sale of a respective one or more items.

In some embodiments, the sale of the one or more items includes an auction of the one or more items. In these embodiments, the method 900 may further include (1) receiving, from the particular client device via the second GUI, a third one or more user interactions indicating a bid for the one or more items, (2) responsive to receiving the one or more third user interactions, determining whether the received bid exceeds a current highest bid for the one or more items, and/or (3) responsive to determining that the bid exceeds the current highest bid, updating stored auction information associated with the auction of the one or more items, the updated stored auction information reflecting the received bid as the current highest bid. Moreover, in these embodiments, the method 900 may still further include (4) identifying a further one or more client computing devices viewing the time-limited social post via the second GUI respectively displayed at each of the further one or more client computing devices, and/or (5) transmitting real-time communications to each of the further one or more client computing devices to cause the real-time information to be automatically updated on the second GUI based upon the updated stored auction information.

In some embodiments, the sale of the one or more items includes an offer for direct purchase of the one or more items. In these embodiments, the method 900 may further include (1) via communications with the particular client device via the second GUI, executing a purchase of the one or more items by a second user of the particular client device, and/or (2) responsive to the purchase, updating stored purchase information associated with the auction of the one or more items, the updated stored purchase information reflecting the purchase by the second user. Moreover, in these embodiments, the method 900 may still further include (3) identifying a further one or more client computing devices viewing the time-limited social post via the second GUI respectively displayed at the further one or more client computing devices, and/or (4) transmitting real-time communications to each of the further one or more client computing devices to cause the real-time information to be automatically updated on the second GUI based upon the updated stored purchase information.

Referring next to FIG. 9B, a computer-implemented method 920 is provided. Generally speaking, the method 920 may be performed by a client computing device associated with a seller (e.g., the mobile computing device 110a of FIG. 1, the seller device 202 introduced in FIG. 2, the seller device 310 of FIGS. 3A-3E, 4A-4I, 7A and/or 7B, and/or the mobile computing device 810 of FIG. 8). Actions of the method 920 may include communications between the client computing device and a server (i.e., one or more servers, e.g., the auction server 124 and/or other servers of FIG. 1, and/or the auction server 224 of FIG. 2).

The method 920 includes receiving, via one or more graphical user interfaces (GUIs) of a client computing device of a first user, a first one or more user interactions (922). The first one or more user interactions may define one or more images or videos to be included in a time-limited social post (“story”) associated with a unique user profile of the first user. In some embodiments, the one or more images or videos include one or more images or videos retrieved from a storage unit of the client computing device (e.g., the first one or more user interactions may include uploading the one or more images and/or videos). In some embodiments, the first one or more user interactions include operation of a camera application to capture at least one of the one or more images or videos. Still additionally or alternatively, in some embodiments, the first one or more user interactions include a selection of one or more images or videos from an item database at the one or more servers (e.g., item catalogue server 132 of FIG. 1).

The method 920 further includes receiving, via the one or more GUIs, a second one or more user interactions (924). The second one or more user interactions may define one or more items to be made available for sale in association with the time-limited social post, the one or more items being among an item inventory associated with the unique user profile. In some embodiments, the second one or more interactions include a selection of the one or more items previously added to the item inventory. Additionally or alternatively, in some embodiments, the second one or more user interactions include interactions to define a new one or more items to be added to the item inventory.

The method 920 still further includes transmitting, to one or more servers, communications indicating the one or more images or videos and the one or more items (926). Transmitting the communications to the one or more servers may cause the time-limited social post to be generated and made available for viewing at each of a plurality of second client computing devices via the one or more servers.

The method 920 may include additional actions, in some embodiments. For example, the method 920 may further include, subsequent to transmitting the communications indicating the one or more images or videos and the one or more items, (1) receive, via the one or more GUIs, a third one or more user interactions indicating an update to one or more parameters associated the sale of the one or more items, and/or (2) transmitting further communications to the one or more servers indicating the update to the one or more parameters to cause the one or more servers to update the time-limited social post as viewed at the second plurality of client computing devices.

In embodiments where the sale of the one or more items includes an auction of the one or more items, the method 920 may further include causing the client computing device to receive, via the one or more GUIs, a third one or more user interactions defining one or more auction parameters for the one or more items. In embodiments, where the sale of the one or more items includes an offer for direct purchase of the one or more items, the method 920 may further include receiving, via the one or more GUIs, a third one or more user interactions defining one or more purchase parameters for the one or more items. Auction or purchase parameters for the items may be displayed at buyer devices as part of the story, enabling buyers to view the detailed item information while potentially bidding on and/or purchasing items via the story.

Referring now to FIG. 9C, a computer-implemented method 940 is provided. Generally speaking, the method 940 may be performed by a client computing device associated with a potential buyer of one or more items featured in a story (e.g., one of the mobile computing devices 110b in FIG. 1, one of the devices 204a-204c of FIG. 2, the buyer device 510 of FIGS. 5A-5H and 6A-6D, and/or the mobile computing device 810 of FIG. 8).

The method 940 includes displaying, via a first graphical user interface (GUI) of a client computing device of a first user, an indication of availability of time-limited social post (“story”) associated with a unique user profile of a second user (942). The time-limited social post is associated with (1) one or more images or videos, and (2) a sale of one or more items.

In some embodiments, the indication is a first indication from among a plurality of indications displayed via the first GUI, each of the plurality of indications respectively indicating a time-limited social media post being available from different respective ones of a plurality of users. That is, different sellers may each post stories to their story view, and the client computing device may display indications of each seller's respective story view. The displayed plurality of indications may be based upon users and/or categories followed by the first user.

The method 940 further includes receiving a first one or more user interactions with the indication (944).

The method 940 still further includes, in response to the first one or more user interactions with the indication, and via communications with one or more servers, obtaining (1) the one or more images or videos, and (2) real-time information defining one or more parameters associated with the sale of the one or more items (946).

In embodiments where the sale includes an auction for the one or more items, the real-time information may define one or more parameters associated with the auction (e.g., item name, item description, starting bid price, current bid price, highest bidder, time remaining in the auction, categories/subcategories, etc.). In these embodiments, the method 940 may further include (1) receiving a second one or more user interactions via the second GUI, the second one or more user interactions indicating a bid for the one or more items, and/or (2) in response to the second one or more user interactions, transmitting communications to the one or more servers indicating the received bid.

In embodiments where the sale includes an offer for direct purchase for the one or more items, the real-time information may define one or more parameters associated with the offer for direct purchase (e.g., item name, item description, current price, quantity of the item available, categories/subcategories, etc.). In these embodiments, the method 940 may further include (1) receiving a second one or more user interactions via the second GUI, the second one or more user interactions indicating a purchase of the one or more items, and/or (2) in response to the second one or more user interactions, transmitting communications to the one or more servers indicating the purchase.

The method 940 still yet further includes displaying the time-limited social post via a second GUI (948). The displaying of the time-limited social post may (1) include displaying the one or more images or videos in conjunction with real-time information associated with the sale of the one or more items, and (2) enable the client computing device to participate in the sale of the one or more items via the post.

The method 940 may include additional actions, in some embodiments. For example, in some embodiments, the method 940 further includes, while displaying the second GUI, automatically receiving, from the one or more servers, further communications indicating an update to the one or more parameters associated with the sale of the one or more items. In these embodiments, the method 940 may still further include automatically updating the display of the second GUI to reflect the updated one or more parameters.

In some embodiments, the method 940 involves navigating between two or more stories from a same user. That is, the time-limited social post from the first user may be a first post from among a plurality of time-limited social posts available from the first user, each of the plurality of time-limited social posts being associated with a respective one or more images or videos and a sale of a respective one or more items. In these embodiments, the method 940 may further include receiving a further one or more user interactions in the second GUI and, in response to the further one or more user interactions, display a second one of the plurality of time-limited social posts via the second GUI.

### Additional Considerations

Although the text herein sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims. By way of example, and not limitation, the disclosure herein contemplates at least the following aspects:

Thus, many modifications and modifications and variations may be made in the techniques and structures described and illustrated herein without departing from the spirit and scope of the present claims. Accordingly, it should be understood that the methods and apparatus described herein are illustrative only and are not limiting upon the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Unless a claim element is defined by reciting the word “means” and a function without the recital of any structure, it is not intended that the scope of any claim element be interpreted based upon the application of 35 U.S.C. § 112(f). The systems and methods described herein are directed to an improvement to computer functionality, and improve the functioning of conventional computers.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more modules of a computer system (e.g., a processor or a group of processors) may be configured by software (e.g., an application or application portion) as a module that operates to perform certain operations as described herein.

In various embodiments, a module may be implemented mechanically or electronically. Accordingly, the term “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which modules are temporarily configured (e.g., programmed), each of the modules need not be configured or instantiated at any one instance in time. For example, where the modules comprise a general-purpose processor configured using software, the general-purpose processor may be configured as respective different modules at different times. Software may accordingly configure a processor, for example, to constitute a particular module at one instance of time and to constitute a different module at a different instance of time.

Modules can provide information to, and receive information from, other modules.

Accordingly, the described modules may be regarded as being communicatively coupled. Where multiple of such modules exist contemporaneously, communications may be achieved through signal transmission (e.g., over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein any reference to “one embodiment” or “an embodiment” means that a particular element, feature, structure, or characteristic described in connection with the embodiment may be included in at least one embodiment. The appearances of the phrase “in one embodiment” in various places in the specification are not necessarily all referring to the same embodiment. In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

Throughout the present disclosure, embodiments are described in which various elements are optional—present in some, but not all, embodiments of the system. Where such elements are depicted in the accompanying figures and, specifically, in figures depicting block diagrams, the optional elements are generally depicted in dotted lines to denote their optional nature.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of skill in the art will appreciate still additional alternative structural and functional designs for generating dynamic user experience applications through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited, and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

By way of example, and not limitation, the disclosure herein contemplates at least the following aspects:
A1. One or more servers comprising: one or more processors; and one or more memories storing non-transitory computer executable instructions that, when executed via the one or more processors, cause the one or more servers to: obtain, from a first client computing device operating on behalf of a first user, first information defining one or more images or videos to be included in a time-limited social post associated with a unique user profile of the first user; obtain, from the first client computing device, second information defining one or more items to be made available for sale in association with the time-limited social post, the one or more items being among an item inventory associated with the unique user profile; generate the time-limited social post based upon the first and second information to thereby make the post available to be viewed, via the one or more servers and for a limited duration of time, at each of a plurality of second client computing devices; and/or cause an indication of availability of the time-limited social post to be displayed via a first graphical user interface (GUI) at each of the plurality of second client computing devices, wherein a user interaction with the indication via the first GUI at a particular client device from among the plurality of second client computing devices causes the particular client device to display the time-limited social post by displaying the one or more images or videos in conjunction with real-time information associated with the sale of the one or more items.
A2. The one or more servers of aspect A1, wherein the non-transitory computer executable instructions that, when executed via the one or more processors, further cause the one or more servers to: via communications with the particular client device from among the plurality of client computing devices, and responsive to the interaction with the indication, cause the particular client device to display a second GUI to display the time-limited social post, the second GUI enabling the particular client device to participate in the sale of the one or more items while displaying the one or more images or videos in conjunction with real-time information associated with the sale of the one or more items.
A3. The one or more servers of aspect A1 or A2, wherein the indication of the availability of the time-limited social post presented via the first GUI is a first indication from among a plurality of indications displayed via the first GUI, each of the plurality of indications respectively indicating a time-limited social media post being available from different respective users from among a plurality of users.
A4. The one or more servers of aspect A2 or A3, wherein the non-transitory computer executable instructions that, when executed via the one or more processors, further cause the one or more servers to: via communications with the particular client device, and responsive to a second one or more user interactions received via the second GUI at the particular client device, cause the particular client device to display a further one or more time-limited social posts associated with the first user, wherein displaying each of the further one or more time-limited social posts comprises displaying a respective one or more images or videos in conjunction with real-time information associated with a sale of a respective one or more items.
A5. The one or more servers of any one of aspects A2-A4, wherein the sale of the one or more items comprises an auction of the one or more items, and wherein the non-transitory computer executable instructions that, when executed via the one or more processors, further cause the one or more servers to: receive, from the particular client device via the second GUI, a third one or more user interactions indicating a bid for the one or more items; responsive to receiving the one or more third user interactions, determine whether the received bid exceeds a current highest bid for the one or more items; and responsive to determining that the bid exceeds the current highest bid, update stored auction information associated with the auction of the one or more items, the updated stored auction information reflecting the received bid as the current highest bid.
A6. The one or more servers of aspect A5, wherein the non-transitory computer executable instructions that, when executed via the one or more processors, further cause the one or more servers to: identify a further one or more client computing devices viewing the time-limited social post via the second GUI respectively displayed at each of the further one or more client computing devices; and transmit real-time communications to each of the further one or more client computing devices to cause the real-time information to be automatically updated on the second GUI based upon the updated stored auction information.
A7. The one or more servers of any one of aspects A2-A4, wherein the sale of the one or more items comprises an offer for direct purchase of the one or more items, and wherein the non-transitory computer executable instructions that, when executed via the one or more processors, further cause the one or more servers to: via communications with the particular client device via the second GUI, execute a purchase of the one or more items by a second user of the particular client device; and responsive to the purchase, update stored purchase information associated with the auction of the one or more items, the updated stored purchase information reflecting the purchase by the second user.
A8. The one or more servers of aspect A7, wherein the non-transitory computer executable instructions that, when executed via the one or more processors, further cause the one or more servers to: identify a further one or more client computing devices viewing the time-limited social post via the second GUI respectively displayed at the further one or more client computing devices; and transmit real-time communications to each of the further one or more client computing devices to cause the real-time information to be automatically updated on the second GUI based upon the updated stored purchase information.
A9. The one or more servers of any one of aspects A1-A8, wherein the first information comprises the one or more images or videos, the one or more images or videos being previously captured or stored by the first client computing device.
A10. The one or more servers of any one of aspects A1-A8, wherein the first information comprises a selection of one or more images or videos stored by the one or more servers.
A11. The one or more servers of any one of aspects A1-A10, wherein the second information comprises a selection of one or more items previously added to the item inventory associated with the unique user profile of the first user.
A12. The one or more servers of any one of aspects A1-A10, wherein the second information comprises information defining a new one or more items to be added to the item inventory associated with the first user, and wherein the non-transitory computer executable instructions that, when executed via the one or more processors, further cause the one or more servers to, responsive to obtaining the second information, add the new one or more items to the item inventory associated with the unique user profile of the first user.
A13. The one or more servers of any one of aspects A1-A12, configured to perform the actions of the one or more servers of any other suitable one of aspects A1-A12.
A14. A computer-implemented method performed via one or more processors, the method comprising: obtaining, from a first client computing device operating on behalf of a first user, first information defining one or more images or videos to be included in a time-limited social post; obtaining, from the first client computing device, second information defining one or more items to be made available for sale in association with the time-limited social post, the one or more items being associated with an inventory of a unique user profile associated with the user; generating the time-limited social post based upon the first and second information to thereby make the post available to be viewed, via the one or more servers and for a limited duration of time, at each of a plurality of second client computing devices; and/or causing an indication of availability of the time-limited social post to be displayed via a first graphical user interface (GUI) at each of the plurality of second client computing devices, wherein a user interaction with the indication via the first GUI at a particular client device from among the plurality of second client computing devices causes the particular client device to display the time-limited social post by displaying the one or more images or videos in conjunction with real-time information associated with the sale of the one or more items.
A15. The computer-implemented method of aspect 14, further comprising the actions of the one or more servers of any one of aspects A1-A13.
A16. One or more computer readable media storing non-transitory computer executable instructions that, when executed via one or more processors of one or more servers, cause the one or more servers to: obtain, from a first client computing device operating on behalf of a first user, first information defining one or more images or videos to be included in a time-limited social post; obtain, from the first client computing device, second information defining one or more items to be made available for sale in association with the time-limited social post, the one or more items being associated with an inventory of a unique user profile associated with the user; generate the time-limited social post based upon the first and second information to thereby make the post available to be viewed, via the one or more servers and for a limited duration of time, at each of a plurality of second client computing devices; and/or cause an indication of availability of the time-limited social post to be displayed via a first graphical user interface (GUI) at each of the plurality of second client computing devices, wherein a user interaction with the indication via the first GUI at a particular client device from among the plurality of second client computing devices causes the particular client device to display the time-limited social post by displaying the one or more images or videos in conjunction with real-time information associated with the sale of the one or more items.
A17. The one or more computer readable media of aspect A16, comprising instructions to perform the actions of the one or more servers of any one of aspects A1-A13.
A18. The one or more computer readable media of aspect A16, comprising instructions to perform the method of aspect A14 or A15.
A19. Any one of aspects A1-18 in combination with any other suitable one of aspects A1-18.
B1. One or more computer readable media storing non-transitory computer executable instructions that, when executed via one or more processors of a client computing device operating on behalf of a first user, cause the client computing device to: receive, via one or more graphical user interfaces (GUIs), a first one or more user interactions defining one or more images or videos to be included in a time-limited social post associated with a unique user profile of the first user; receive, via the one or more GUIs, a second one or more user interactions defining one or more items to be made available for sale in association with the time-limited social post, the one or more items being among an item inventory associated with the unique user profile; and/or transmit, to one or more servers, communications indicating the one or more images or videos and the one or more items to cause the time-limited social post to be generated and made available for viewing at each of a plurality of second client computing devices via the one or more servers.
B2. The one or more computer readable media of aspect B1, wherein the one or more images or videos include one or more images or videos retrieved from a storage unit of the client computing device.
B3. The one or more computer readable media of aspect B1 or B2, wherein the first one or more user interactions include operation of a camera application to capture at least one of the one or more images or videos.
B4. The one or more computer readable media of any one of aspects B1-B3, wherein the first one or more user interactions include a selection of one or more images or videos from an item database at the one or more servers.
B5. The one or more computer readable media of any one of aspects B1-B4, wherein the second one or more user interactions include a selection of the one or more items previously added to the item inventory.
B6. The one or more computer readable media of any one of aspects B1-B4, wherein the second one or more user interactions include interactions to define a new one or more items to be added to the item inventory.
B7. The one or more computer readable media of any one of aspects B1-B6, wherein the sale of the one or more items comprises an auction of the one or more items, and wherein the non-transitory computer executable instructions, when executed via one or more processors, further cause the client computing device to receive, via the one or more GUIs, a third one or more user interactions defining one or more auction parameters for the one or more items.
B8. The one or more computer readable media of any one of aspects B1-B6, wherein the sale of the one or more items comprises an offer for direct purchase of the one or more items, and wherein the non-transitory computer executable instructions, when executed via one or more processors, further cause the client computing device to receive, via the one or more GUIs, a third one or more user interactions defining one or more purchase parameters for the one or more items.
B9. The one or more computer readable media of any one of aspects B1-B8, wherein the non-transitory computer executable instructions, when executed via one or more processors, further cause the client computing device to, subsequent to transmitting the communications indicating the one or more images or videos and the one or more items: receive, via the one or more GUIs, a third one or more user interactions indicating an update to one or more parameters associated the sale of the one or more items; and transmit further communications to the one or more servers indicating the update to the one or more parameters to cause the one or more servers to update the time-limited social post as viewed at the second plurality of client computing devices.
B10. The one or more computer readable media of any one of aspects B1-B9, in combination with the one or more computer readable media of any other suitable one of aspects B1-B9.
B11. A computer-implemented method executed via one or more processors, the method comprising: receiving, via one or more graphical user interfaces (GUIs) of a client computing device of a first user, a first one or more user interactions defining one or more images or videos to be included in a time-limited social post associated with a unique user profile of the first user; receiving, via the one or more GUIs, a second one or more user interactions defining one or more items to be made available for sale in association with the time-limited social post, the one or more items being among an item inventory associated with the unique user profile; and/or transmitting, to one or more servers, communications indicating the one or more images or videos and the one or more items to cause the time-limited social post to be generated and made available for viewing at each of a plurality of second client computing devices via the one or more servers.
B12. The computer-implemented method of aspect B11, further comprising the actions performed by the client computing device of any one of aspects B1-B10.
B13. A client computing device comprising: one or more processors; and one or more memories store non-transitory computer executable instructions that, when executed via the one or more processors, cause the client computing device, operating on behalf of a first user, to: receive, via one or more graphical user interfaces (GUIs), a first one or more user interactions defining one or more images or videos to be included in a time-limited social post associated with a unique user profile of a first user; receive, via the one or more GUIs, a second one or more user interactions defining one or more items to be made available for sale in association with the time-limited social post, the one or more items being among an item inventory associated with the unique user profile; and/or transmit, to one or more servers, communications indicating the one or more images or videos and the one or more items to cause the time-limited social post to be generated and made available for viewing at each of a plurality of second client computing devices via the one or more servers.
B14. The client computing device of aspect B13, comprising instructions to perform the actions of the client computing device of any one of aspects B1-B10.
B15. The client computing device of aspect B13, comprising instructions to perform the method of aspect B13 or B14.
B16. Any one of aspects B1-B15 in combination with any other suitable one of aspects B1-B15.
C1. One or more computer readable media storing non-transitory computer executable instructions that, when executed via one or more processors of a client computing device operating on behalf of a first user, cause the client computing device to: display, via a first graphical user interface (GUI) an indication of availability of time-limited social post associated with a unique user profile of a second user, the time-limited social post being associated with (1) one or more images or videos, and (2) a sale of one or more items; receive a first one or more user interactions with the indication; in response to the first one or more user interactions with the indication, and via communications with one or more servers, obtain (1) the one or more images or videos, and (2) real-time information defining one or more parameters associated with the sale of the one or more items; and/or display the time-limited social post via a second GUI, the displaying of the time-limited social post (1) comprising displaying the one or more images or videos in conjunction with real-time information associated with the sale of the one or more items, and (2) enabling the client computing device to participate in the sale of the one or more items via the post.
C2. The one or more computer readable media of aspect C1, wherein the indication is a first indication from among a plurality of indications displayed via the first GUI, each of the plurality of indications respectively indicating a time-limited social media post being available from different respective ones of a plurality of users.
C3. The one or more computer readable media of aspect C1, wherein the displayed plurality of indications are based upon one or more users or one or more categories followed by the first user.
C4. The one or more computer readable media of any one of aspects C1-C3, wherein the sale comprises an auction for the one or more items, and wherein the real-time information defines one or more parameters associated with the auction.
C5. The one or more computer readable media of aspect C4, wherein the instructions, when executed via the one or more processors, further cause the client computing device to: receive a second one or more user interactions via the second GUI, the second one or more user interactions indicating a bid for the one or more items; and in response to the second one or more user interactions, transmit communications to the one or more servers indicating the received bid.
C6. The one or more computer readable media of any one of aspects C1-C3, wherein the sale comprises an offer for direct purchase of the one or more items, and wherein the real-time information defines one or more parameters associated with the offer for direct purchase.
C7. The one or more computer readable media of aspect C6, wherein the instructions, when executed via the one or more processors, further cause the client computing device to: receive a second one or more user interactions via the second GUI, the second one or more user interactions indicating a purchase of the one or more items; and in response to the second one or more user interactions, transmit communications to the one or more servers indicating the purchase.
C8. The one or more computer readable media of any one of aspects C1-C7, wherein the instructions, when executed via the one or more processors, further cause the client computing device to: while displaying the second GUI, automatically receive, from the one or more servers, further communications indicating an update to the one or more parameters associated with the sale of the one or more items; and automatically update the display of the second GUI to reflect the updated one or more parameters.
C9. The one or more computer readable media of any one of aspects C1-C8, wherein the time-limited social post from the first user is a first post from among a plurality of time-limited social posts available from the first user, each of the plurality of time-limited social posts being associated with a respective one or more images or videos and a sale of a respective one or more items, and wherein the instructions, when executed via the one or more processors, further cause the client computing device to: receive a further one or more user interactions in the second GUI; and in response to the further one or more user interactions, display a second one of the plurality of time-limited social posts via the second GUI.
C10. The one or more computer readable media of any one of aspects C1-C9, in combination with the one or more computer readable media of any other suitable one of aspects C1-C9.
C11. A computer-implemented method executed via one or more processors, the method comprising: displaying, via a first graphical user interface (GUI) of a client computing device of a first user, an indication of availability of time-limited social post associated with a unique user profile of a second user, the time-limited social post being associated with (1) one or more images or videos, and (2) a sale of one or more items; receiving a first one or more user interactions with the indication; in response to the first one or more user interactions with the indication, and via communications with one or more servers, obtaining (1) the one or more images or videos, and (2) real-time information defining one or more parameters associated with the sale of the one or more items; and/or displaying the time-limited social post via a second GUI, the displaying of the time-limited social post (1) comprising displaying the one or more images or videos in conjunction with real-time information associated with the sale of the one or more items, and (2) enabling the client computing device to participate in the sale of the one or more items via the post.
C12. The computer-implemented method of aspect C11, further comprising the actions performed by the client computing device of any one of aspects C1-C-10.
C13. A client computing device comprising: one or more processors; and one or more memories store non-transitory computer executable instructions that, when executed via the one or more processors, cause the client computing device, operating on behalf of a first user, to: display, via a first graphical user interface (GUI) an indication of availability of time-limited social post associated with a unique user profile of a second user, the time-limited social post being associated with (1) one or more images or videos, and (2) a sale of one or more items; receive a first one or more user interactions with the indication; in response to the first one or more user interactions with the indication, and via communications with one or more servers, obtain (1) the one or more images or videos, and (2) real-time information defining one or more parameters associated with the sale of the one or more items; and/or display the time-limited social post via a second GUI, the displaying of the time-limited social post (1) comprising displaying the one or more images or videos in conjunction with real-time information associated with the sale of the one or more items, and (2) enabling the client computing device to participate in the sale of the one or more items via the post.
C14. The client computing device of aspect C13, comprising instructions to perform the actions of the client computing device of any one of aspects C1-C10.
C15. The client computing device of aspect C13, comprising instructions to perform the method of aspect C11 or C12.
C16. Any one of aspects C1-C15 in combination with any other suitable one of aspects C1-C15.
D. Any one of aspects A1-19, B1-15, or C1-C16 in combination with any other one of aspects A1-19, B1-15, or C1-C16.

What is claimed is:

1. A computer-implemented method executed via one or more processors, the method comprising:
receiving, via one or more graphical user interfaces (GUIs) of a client computing device of a first user, a first one or more user interactions defining one or more images or videos to be included in a time-limited social post associated with a unique user profile of the first user;
receiving, via the one or more GUIs, a second one or more user interactions defining one or more items to be made available for sale in association with the time-limited social post, the one or more items being among an item inventory associated with the unique user profile; and
transmitting, to one or more servers, communications indicating the one or more images or videos and the one or more items to cause the time-limited social post to be generated and made available for viewing at each of a plurality of second client computing devices via the one or more servers.

2. The computer-implemented method of claim 1, wherein the first one or more user interactions include operation of a camera application of the client computing device to capture at least one of the one or more images or videos.

3. The computer-implemented method of claim 3, wherein the first one or more user interactions include a selection of one or more images or videos from an item database at the one or more servers.

4. The computer-implemented method of claim 1, wherein the second one or more user interactions include interactions to define a new one or more items to be added to the item inventory.

5. The computer-implemented method of claim 1, wherein the sale of the one or more items comprises an auction of the one or more items, and wherein the method further comprises receiving, at the client computing device via the one or more GUIs, a third one or more user interactions defining one or more auction parameters for the one or more items.

6. The computer-implemented method of claim 1, wherein the sale of the one or more items comprises an offer for direct purchase of the one or more items, and wherein the method further comprises receiving, at the client computing device via the one or more GUIs, a third one or more user interactions defining one or more purchase parameters for the one or more items.

7. The computer-implemented method of claim 1, further comprising, subsequent to transmitting the communications indicating the one or more images or videos and the one or more items:
receiving, via the one or more GUIs, a third one or more user interactions indicating an update to one or more parameters associated the sale of the one or more items; and
transmitting further communications to the one or more servers indicating the update to the one or more parameters to cause the one or more servers to update the time-limited social post as viewed at the second plurality of client computing devices.

8. One or more computer readable media storing non-transitory computer executable instructions that, when executed via one or more processors of a client computing device operating on behalf of a first user, cause the client computing device to:
receive, via one or more graphical user interfaces (GUIs), a first one or more user interactions defining one or more images or videos to be included in a time-limited social post associated with a unique user profile of the first user;
receive, via the one or more GUIs, a second one or more user interactions defining one or more items to be made available for sale in association with the time-limited social post, the one or more items being among an item inventory associated with the unique user profile;
transmit, to one or more servers, communications indicating the one or more images or videos and the one or more items to cause the time-limited social post to be generated and made available for viewing at each of a plurality of second client computing devices via the one or more servers.

9. The one or more non-transitory computer readable media of claim 22, wherein the first one or more user interactions include operation of a camera application of the client computing device to capture at least one of the one or more images or videos.

10. The one or more non-transitory computer readable media of claim 22, wherein the first one or more user interactions include a selection of one or more images or videos from an item database at the one or more servers.

11. The one or more non-transitory computer readable media of claim 22, wherein the second one or more user interactions include interactions to define a new one or more items to be added to the item inventory.

12. The one or more non-transitory computer readable media of claim 22, wherein the sale of the one or more items comprises an auction of the one or more items, and wherein the non-transitory instructions, when executed via the one or more processors, cause the client computing device to receive, via the one or more GUIs, a third one or more user interactions defining one or more auction parameters for the one or more items.

13. The one or more non-transitory computer readable media of claim 22, wherein the sale of the one or more items comprises an offer for direct purchase of the one or more items, and wherein the non-transitory computer executable instructions, when executed via the one or more processors, further cause the client computing device to receive, via the one or more GUIs, a third one or more user interactions defining one or more purchase parameters for the one or more items.

14. The one or more non-transitory computer readable media of claim 22, wherein the non-transitory computer executable instructions, when executed via the one or more processors, further cause the client computing device to, subsequent to transmitting the communications indicating the one or more images or videos and the one or more items:
receive, via the one or more GUIs, a third one or more user interactions indicating an update to one or more parameters associated the sale of the one or more items; and
transmit further communications to the one or more servers indicating the update to the one or more parameters to cause the one or more servers to update the time-limited social post as viewed at the second plurality of client computing devices.

15. A computer-implemented method performed via one or more processors, the method comprising:
obtaining, from a first client computing device operating on behalf of a first user, first information defining one or more images or videos to be included in a time-limited social post;
obtaining, from the first client computing device, second information defining one or more items to be made available for sale in association with the time-limited social post, the one or more items being associated with an inventory of a unique user profile associated with the user;
generating the time-limited social post based upon the first and second information to thereby make the post available to be viewed, via the one or more servers and for a limited duration of time, at each of a plurality of second client computing devices; and
causing an indication of availability of the time-limited social post to be displayed via a first graphical user interface (GUI) at each of the plurality of second client computing devices, wherein a user interaction with the indication via the first GUI at a particular client device from among the plurality of second client computing devices causes the particular client device to display the time-limited social post by displaying the one or more images or videos in conjunction with real-time information associated with the sale of the one or more items.

16. A computer-implemented method performed via one or more processors, the method comprising:
obtaining, from a first client computing device operating on behalf of a first user, first information defining one or more images or videos to be included in a time-limited social post;
obtaining, from the first client computing device, second information defining one or more items to be made available for sale in association with the time-limited social post, the one or more items being associated with an inventory of a unique user profile associated with the user;
generating the time-limited social post based upon the first and second information to thereby make the post available to be viewed, via the one or more servers and for a limited duration of time, at each of a plurality of second client computing devices; and
causing an indication of availability of the time-limited social post to be displayed via a first graphical user interface (GUI) at each of the plurality of second client computing devices, wherein a user interaction with the indication via the first GUI at a particular client device from among the plurality of second client computing devices causes the particular client device to display the time-limited social post by displaying the one or more images or videos in conjunction with real-time information associated with the sale of the one or more items.
